(19) United States
(12) Patent Application Publication
(10) Pub. No.: US 2024/0011954 A1
(43) Pub. Date: Jan. 11, 2024

(54) GAS CHROMATOGRAPHY SYSTEMS AND METHODS WITH DIAGNOSTIC AND PREDICTIVE MODULE

(71) Applicant: Agilent Technologies, Inc., (US)

(72) Inventors: Simone Novaes-Card, Wilmington, DE (US); Brian David Fitz, Santa Clara, CA (US); Steven Kirk, Santa Clara, CA (US); Joseph D'Alessio, Santa Clara, CA (US); Brent Casper, Santa Clara, CA (US)

(21) Appl. No.: 18/037,483

(22) PCT Filed: Nov. 16, 2021
(86) PCT No.: PCT/US21/59518

§ 371 Date: May 17, 2023

Related U.S. Application Data
(60) Provisional application No. 63/114,835, filed on Nov. 17, 2020.

(51) Int. Cl. G01N 30/52; G01N 30/88

(52) U.S. Cl. CPC G01N 30/52; G01N 30/88; G01N 2030/025

(57) ABSTRACT

The present invention provides a gas chromatography system (GC) including a GC column configured for a chromatographic separation of a sample comprising one or more analytes, a GC detector connected to the exit of the GC column, and a controller connected to the GC system. The controller is configured to generate a simulated chromatographic separation using a chromatographic model that calculates at least one chromatographic parameter of the analyzed sample. The controller further configured to execute a chromatographic separation of the sample and execute chromatographic performance monitoring that includes a comparison of at least one chromatographic parameter to the simulated chromatographic separation and/or reference chromatographic separation, determine if at least one chromatographic parameter has fallen outside of a performance control limit and/or predict if the chromatographic parameter will fall outside the performance control limit, and perform an automated GC troubleshooting procedure to determine the cause of the performance issue.

### CROSS-REFERENCE TO RELATED APPLICATIONS

This application claims priority to and benefit of U.S. Provisional Patent Application No. 63/114,835, filed on Nov. 17, 2020, the contents of which are incorporated herein by reference in its entirety.

### BACKGROUND

Gas chromatography (GC) is used to analyze and detect the presence of many different substances in a sample. The function of a gas chromatograph is to separate the components of a chemical sample, known as analytes, and detect the identity and/or the concentration of those components. The separation is frequently accomplished using a capillary GC column. In some instances, this column is essentially a piece of fused silica tubing with a coating on the inside. The column can contain a stationary phase that interacts with the sample to separate the components. The GC column can remain isothermal throughout an analysis or be ramped in temperature.

Traditionally, when a GC instrument requires maintenance the instrument may experience a hardware related shutdown (i.e., the septum has a leak due to too many consecutive injections) or the required maintenance may be prompted by chromatographic performance degradation (i.e., the stationary phase has degraded due to extensive use and the analytes are not separating as efficiently). In such situations, the user must analyze data from previous run(s) of the instrument to determine what caused the hardware failure and/or chromatographic performance degradation. Performance degradation may manifest itself as changes in chromatographic features such as but not limited to: retention time shift, peak area change, and/or peak shape alteration. As a result, the user must decide which parts to change (e.g., liner, syringe, septum, and/or column), and continue changing parts until the performance returns to acceptable levels. The decision of which maintenance procedures to perform may be outlined or otherwise prescribed by a Standard Operating Procedure that suggests changing hardware at specific time intervals, even if the instrument is functioning normally or the hardware does not need to be replaced. However, the Standard Operating Procedure may not provide specific guidance on which maintenance procedures to perform when the instrument experiences a failure and/or chromatographic performance degradation during sample analysis. Rather, determination of which maintenance procedures to perform may be heavily influenced by user experience.

The GC instrument may encounter a performance issue that is non-trivial to resolve and requires extensive investigation to determine the cause of the issue. As such, the user may need to resort to instrument operational manuals, websites directed to GC instrument repair, or consultation with an expert to determine the cause of the performance issue. Current troubleshooting guides attempt to relate specific symptoms with suggested remedies. However, there are often many remedies for a single symptom, so the user must often resort to trial and error until they arrive at the proper fix.

Current chromatographic troubleshooting methods utilize external stand-alone tools accessible on external websites or troubleshooting guides provided by the GC instrument manufacturer. Several disadvantages of these methods are that they are from external sources, they may not be specific to the actual GC instrument configuration or instrument manufacturer/model, they can't take advantage of using data stored on the instrument that may not be accessible to users, and/or they provide only generic guidelines to the user for troubleshooting the specific chromatographic issue observed on their particular instrument. As such, this will require the user to spend time searching for troubleshooting assistance and attempt certain maintenance procedures that are not for their particular instrument. Accordingly, there is a need for automated methods that can predict when maintenance is going to be required as well as automated troubleshooting assistance that can precisely direct the user what to fix on their particular GC instrument.

### SUMMARY OF THE INVENTION

As an aspect of the present invention, a method for operating a gas chromatography (GC) system is provided. The method comprises generating a simulated chromatographic separation using a chromatographic model based on a configuration of the GC system, wherein the chromatographic model calculates at least one chromatographic parameter of a sample analyzed by the GC system. The method also comprises performing a sample chromatographic separation using the GC system, thereby generating a sample chromatogram of the sample analyzed by the GC system and collecting performance data associated with the sample chromatographic separation, the performance data includes at least one chromatographic parameter of the sample. The method also comprises performing chromatographic performance monitoring configured to analyze the sample chromatographic separation. For example, the chromatographic performance monitoring includes a comparison of at least one chromatographic parameter from the sample chromatographic separation to the simulated chromatographic separation and/or a reference chromatographic separation and determines if the at least one chromatographic parameter has fallen outside of a performance control limit and/or predicts if and/or when the at least one chromatographic parameter will fall outside the performance control limit. The method also comprises performing an automated troubleshooting procedure that uses results of the chromatographic performance monitoring and the chromatographic model to predict an expected maintenance task and transmitting a maintenance notification of the GC system including the expected maintenance task.

As another aspect, a gas chromatography (GC) system for analyzing a sample is provided. The GC system comprises a GC column comprising an entrance and an exit and the GC column is configured for chromatographic separation of a sample comprising one or more analytes. The GC system also comprises a GC detector fluidically connected to the exit of the GC column and a controller communicably connected at least to the GC detector. The controller of the GC system is configured to generate a simulated chromatographic separation using a chromatographic model based on a configuration of the GC system, and the chromatographic model calculates at least one chromatographic parameter of the sample analyzed by the GC system. The controller also executes a chromatographic separation of the sample loaded into the GC system and collects performance data associated with the chromatographic separation of the sample, the performance data comprises at least one chromatographic parameter of the sample. The controller also executes a chromatographic performance monitoring configured to analyze the chromatographic separation of the sample. For example, the chromatographic performance monitoring comprises a comparison of the at least one chromatographic parameter from the sample chromatographic separation to the simulated chromatographic separation and/or a reference chromatographic separation and determines if the at least one chromatographic parameter has fallen outside of a performance control limit and/or predicts if and/or when the at least one chromatographic parameter will fall outside the performance control limit. The controller also executes an automated troubleshooting procedure that uses results of the chromatographic performance monitoring and the chromatographic model to predict an expected maintenance task of the GC system. The controller then generates and transmits a maintenance notification including the expected maintenance task of the GC system. For example, the maintenance notification can be transmitted to an external electronic device such as a smart phone, a computer, a tablet, or other such electronic device.

As yet another aspect, a gas chromatography (GC) system for analyzing a sample is provided. The GC system comprises a GC column comprising an entrance and an exit, and the GC column is configured for chromatographic separation of a sample comprising one or more analytes. The GC system also comprises a GC detector fluidically connected to the exit of the GC column and at least one sensor configured to collect instrument data of the GC system. The GC system also comprises a controller that is communicably connected to the GC detector and the at least one sensor. The controller is configured to execute a chromatographic separation of the sample loaded into the GC system and generate a simulated chromatographic separation of the sample utilizing the instrument data collected by the at least one sensor. The controller generates the simulated chromatographic separation in real-time during the chromatographic separation of the sample.

The method and operation of the GC system described herein can be performed by a diagnostic and predictive module incorporated with and/or communicably connected to the controller, as described below.

### BRIEF DESCRIPTION OF THE DRAWINGS

The present teachings are best understood from the following detailed description when read with the accompanying figures. The features are not necessarily drawn to scale.

FIG. 1 is a schematic block diagram of a GC system including a diagnostic and predictive module in accordance with a representative embodiment.

FIG. 2 is a schematic flow diagram illustrating use of chromatographic performance monitoring, chromatographic modelling and an automated GC troubleshooting procedure by the diagnostic and predictive module of FIG. 1, in accordance with a representative embodiment.

FIG. 3 illustrates a control chart generated by the diagnostic and predictive module of FIG. 1, showing a retention time shift of the sample, in accordance with a representative embodiment.

FIG. 4 is a schematic flow diagram illustrating execution of a chromatographic modelling application by the diagnostic and predictive module of FIG. 1, in accordance with a representative embodiment.

FIGS. 5A, 5B, and 5C are schematic flow diagrams illustrating the execution of a decision tree by the diagnostic and predictive module of FIG. 1, in accordance with a representative embodiment.

FIG. 6 is a schematic flow diagram illustrating the execution of a decision tree by the diagnostic and predictive module of FIG. 1, showing the reduction of possible solutions to provide a specific solution to a chromatographic performance issue, in accordance with a representative embodiment.

FIG. 7A, is a graphical chart generated by the diagnostic and predictive module of FIG. 1, showing the overlay of the reference chromatogram and the simulated chromatogram, in accordance with a representative embodiment.

FIG. 7B, is a graphical chart generated by the diagnostic and predictive module of FIG. 1, showing the comparison of the reference chromatogram and a sample chromatogram from a failed peak evaluation, in accordance with a representative embodiment.

FIG. 7C is a control chart generated by the diagnostic and predictive module of FIG. 1, showing a retention time shift of the sample, in accordance with a representative embodiment.

FIG. 8 is a schematic flow diagram of the questions requiring user input with and without troubleshooting using information from the GC system.

FIG. 9 is a schematic flow diagram of the process of enabling, configuring, and using the diagnostic and predictive module.

### DETAILED DESCRIPTION

The GC system of the present disclosure is configured to utilize chromatographic performance monitoring, chromatographic modelling, and an automated GC troubleshooting procedure as part of the diagnostic and predictive maintenance tools that predict future instrument performance and/or maintenance issues before they occur. Additionally, the diagnostic and predictive maintenance tools can be used to determine which specific maintenance tasks to perform to correct the instrument performance and/or maintenance issues. The GC system of the present disclosure utilizes the diagnostic and predictive maintenance tools to make the instrument more intelligent (i.e., less required user interaction and more of the instrument “knowing”) and easier to use. Additionally, the GC system of the present disclosure may reduce unexpected downtime because the diagnostic and predictive maintenance tools predict an instrument failure before the failure or maintenance issue actually occurs. The diagnostic and predictive maintenance tools also reduce unexpected downtime because they can determine and suggest which maintenance tasks are more likely to correct the upcoming failure or maintenance issue of the GC system.

In some embodiments, the diagnostic and predictive maintenance tools of the present disclosure utilize chromatographic performance monitoring, chromatographic modelling, and an automated GC troubleshooting procedure combined with chromatographic performance evaluations (e.g., blank evaluation, detector evaluation, and peak evaluation), control charting, user input, diagnostic test results (e.g. carrier gas pressure check, leak and restriction test, septum purge test, split vent restriction test, jet restriction test, FID leakage current test, and pressure decay test), and/or instrument sensor data (e.g., temperature, pressure, gas flow, valve state, motor step, sample injection count, motor current value, etc.) to predict future GC system performance and/or maintenance issues. Accordingly, the GC system of the present disclosure provides an improvement over current GC systems because the user of such current systems is unable to detect performance and/or maintenance issues until the issue actually occurs. That is, users of current GC systems generally must take a reactive approach (i.e., waiting until a failure occurs) to performance monitoring and maintenance of the GC system instead of taking a proactive approach (i.e., identify performance degradation and perform maintenance before the failure occurs). In the reactive approach, samples may be analyzed using a system that is not performing properly, resulting in wasted samples and analysis time. Additionally, the GC system of the present disclosure provides an improvement over current GC systems because the GC system can determine that a performance and/or maintenance issue occurred and immediately stop the sample analysis sequence such that no additional samples are run while the GC system is not functioning properly.

In some embodiments, the diagnostic and predictive maintenance tools of the present disclosure incorporate automated diagnostic troubleshooting steps to correct performance and/or maintenance issues. Such automated diagnostic troubleshooting steps save the user time and money from making unnecessary repairs or investigating unrelated components of the GC system by guiding the user to investigate specific components associated with the performance and/or maintenance issues. As such, the diagnostic and predictive maintenance tools of the present disclosure reduce the unexpected downtime of the GC system because the user can decide when they want to address a performance and/or maintenance issue before it occurs and the GC system provides an intelligent starting point during troubleshooting to quickly perform the necessary repairs to the GC system.

In some embodiments, the diagnostic and predictive maintenance tools of the present disclosure improve the user experience by informing the user when the system is not functioning optimally thus providing better chromatography results. For example, utilizing chromatographic modelling and chromatographic performance monitoring enables the GC system (and the user of the system) to optimize and compare instrument performance to a desired performance such as a “theoretical best-case scenario.” If performance is found to be lacking, the automated GC troubleshooting procedure can be activated to guide the user in solving their maintenance issues. As such, the diagnostic and predictive maintenance tools generate an indication of instrument performance to confirm that the instrument is performing as expected by the user and/or to within instrument specifications.

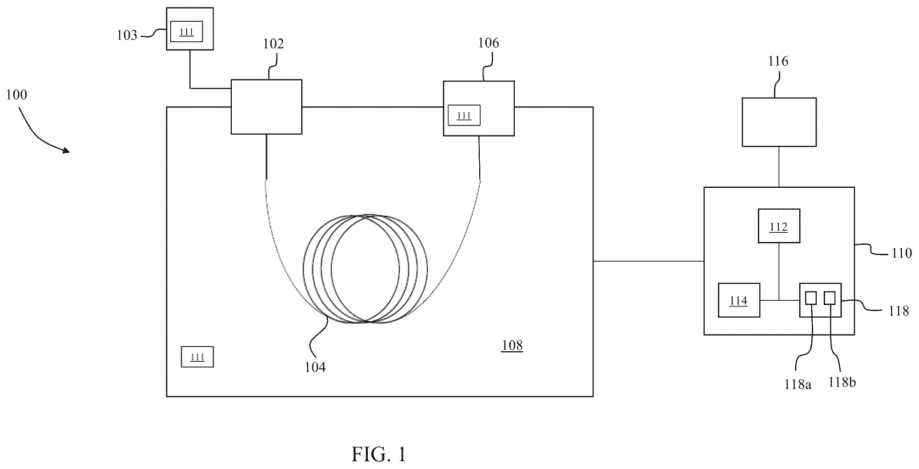

FIG. 1 is a simplified schematic block diagram of a representative GC system 100. Many aspects of the GC system 100 are well known and widely used. As such, the GC system 100 described herein is intended to be broadly representative of available and/or modified GC systems, and particular selections and details of various components of the GC system 100 can be selected by users or others in the field. The GC system 100 comprises a sample inlet or injection port 102 for injecting a sample into the GC system 100 for analysis. For example, the sample is injected into the injection port 102 where, if not already in a gaseous state, it is vaporized into the gaseous state for analysis by the GC system 100. Moreover, a carrier gas supply 103 is fluidically connected to the injection port 102 to supply a carrier gas, such as but not limited to, helium, hydrogen, nitrogen, or other such inert gas, that transports the injected sample from the injection port 102 through the GC system 100.

A sample introduction system or sampler (not shown) can be used to inject the sample into the injection port 102. The type of sampler used may depend on the phase of the sample being injected (liquid or gas). Different types of samplers include, but are not limited to, automatic liquid samplers (ALS), headspace samplers, various configurations of valves, thermal desorption samplers, and other types of sample introduction systems.

In various embodiments, the injection port 102 is also fluidically connected to a column 104, which may be selected from a wide variety of columns utilized to achieve separation of components of a sample by gas chromatography. It should be appreciated that while one column is shown, certain embodiments of the GC system can include multiple columns. For example, GC systems configured for backflushing, detector splitting, or other pneumatic switching can include multiple columns. The carrier gas transports the sample to the column 104 for separation, and the column 104 separates the components of the gaseous sample, such as a vaporized sample, to produce one or more analytes of interest for analysis by the GC system 100. In certain embodiments, the column 104 may be a capillary column and/or may comprise fused silica tubing with a coating on the inner portions of the tubing. In some embodiments, a stationary phase coating interacts with the sample injected into the injection port 102 to separate the components of the sample. In various embodiments, dimensions of the column 104 include an inside diameter range of 100 microns to 530 microns and a length range of 5 meters to 60 meters. However, it will be appreciated that other column dimensions can be utilized in the present GC systems.

In the illustrated embodiment, the column 104 is also fluidically connected to a detector 106 that receives the separated components (i.e. analytes of the sample) after the sample is transported through the column 104. As such, the detector 106 analyzes the separated sample components to detect the presence and/or the quantity of sample analytes separated by the column 104. In certain embodiments, the detector 106 is a GC detector selected from the group consisting of a flame ionization detector (FID), a mass selective detector (MSD), a thermal conductivity detector (TCD), an electron capture detector (ECD), a nitrogen phosphorus detector (NPD), a sulfur chemiluminescence detector (SCD), a nitrogen chemiluminescence detector (NCD), a flame photometric detector (FPD), and a helium ionization detector (HID). However, it will be understood that the use of one or more such detectors is merely exemplary, and many other analyte detectors can be used in GC systems. It will also be understood that more than one detector may be fluidically connected to the outlet of the column(s) of the GC system.

The GC system 100 further includes a column heater 108, such as an oven, a convection heater, a conduction heater, an air bath, or other such heating device for heating certain GC system components. More specifically, the column heater 108 can be controlled, via a controller 110, to heat or cool the column 104 and other flow path components to desired temperatures. For example, the column heater 108 is configured to heat the column 104 up to 450° C., depending on the analysis being performed. In various embodiments, the column heater 108 can be configured to heat the column 104 such that the column 104 remains isothermal during sample analysis. Alternatively, the column heater 108 can be configured to ramp the temperature of the column 104 during sample analysis. Additionally, the column heater 108 can be configured with a cryogenic cooling system to cool the column to below ambient temperatures. It will be understood that the injection port 102 and detector 106 may include separate heating devices for maintaining the temperatures of the injection port 102 and detector 106, respectively. In some embodiments, there may be additional heaters not directly described here that heat other components of the GC system.

In the illustrated embodiment, the controller 110 is communicably connected, directly or indirectly, to the column heater 108, the detector 106, the injection port 102, one or more sensors 111, and other components of the GC system 100. In certain embodiments, the controller can be an onboard computing component that is physically incorporated into the GC system housing that contains the column, detector, column heater, and other components of the GC system. In certain other embodiments, the controller can be one or more separate computing device and/or other such controlling device that is internal and/or external to the GC system housing. The one or more sensors 111 are positioned in various locations of the GC system 100 and configured to collect operational and/or diagnostic data. The one or more sensors 111 utilized by the GC system 100 can include (but is not limited to) sensors such as an inlet pressure sensor, an inlet total flow sensor, a septum purge pressure sensor, an auxiliary pressure sensor, a heater duty cycle sensor, a detector signal sensor, a temperature zone sensor (e.g., on or in the inlet, detector, heater, sample introduction devices, valves, etc.), or other such GC system sensors.

In some embodiments, the controller 110 includes a processor 112, such as but not limited to, a single-core processor, a multi-core processor, a logic device, or other such data processing circuitry, configured to execute, analyze, and process data and information of the GC system 100. The controller 110 can include a memory device 114 communicably connected to the processor 112. The memory device 114 may be configured as a volatile memory device (e.g., SRAM and DRAM), a non-volatile memory device (e.g., flash memory, ROM, and hard disk drive), or any combination thereof. In various embodiments, the memory device 114 may store executable code and other such information that is generated and/or processed by the processor 112 during operation of the GC system 100.

In the illustrated embodiment, the GC system 100 also includes an input/output device 116 communicably connected to the controller 110. The input/output device 116 is configured to enable an operator and/or user to receive information from the controller 110 and to input information and parameters into the controller 110. In various embodiments, such information and parameters can be stored in the memory device 114, accessed by the processor 112, and output to the input/output device 116. For example, the input/output device 116 can include a monitor, display device, touchscreen device, keyboard, microphone, joystick, dial, button, or other such device to enable input and output of information and parameters. As such, the input/output device 116 may be utilized to input information into the controller 110 and output or otherwise display information and data generated by the processor 112 of the GC system 100.

The GC system 100 further includes a diagnostic and predictive module 118. In some embodiments, the diagnostic and predictive module 118 is incorporated with the controller 110 and communicably connected to the processor 112 and/or the memory device 114. In various embodiments, the diagnostic and predictive module 118 executes or otherwise performs chromatographic performance monitoring, chromatographic modelling, and an automated GC troubleshooting procedure to determine and/or predict performance degradation of the GC system 100. As such, the diagnostic and predictive module 118 may include one or more hardware devices, software, firmware, and/or any such combination thereof to execute chromatographic performance monitoring, chromatographic modelling, automated GC troubleshooting procedure, and/or any other such diagnostic monitoring of the GC system 100.

In various embodiments, the diagnostic and predictive module 118 may include a processor 118a and a memory device 118b separate from the processor 112 and memory device 114 of the controller 110. In such embodiments, the processor 118a executes instructions and analyzes data stored in the memory device 118b. Additionally, the memory device 118b stores software and/or firmware that includes executable code to be processed by the processor 118a for the execution of instructions of the diagnostic and predictive module 118. Furthermore, the memory device 118b may store data and information associated with one or more expected maintenance tasks from a plurality of different maintenance tasks of the GC system 100 that the diagnostic and predictive module 118 utilizes during the automated GC troubleshooting procedure of the GC system 100. While the diagnostic and predictive module 118 is shown as being incorporated with the controller 110, it should be appreciated that in certain embodiments the diagnostic and predictive module may be a separate component from the controller.

In various embodiments, the diagnostic and predictive module 118 of the GC system 100 provides significant advantages over prior approaches to improve reliability and reduce unexpected downtime of GC systems. One advantage provided by the diagnostic and predictive module 118 is the ability to predict a timeframe of a future performance degradation and/or maintenance issue of the GC system 100 and to predict a failure mode associated with the cause of the future performance degradation and/or maintenance issue. That is, the diagnostic and predictive module 118 can determine when for example, after how many injections and/or after a specified amount of instrument run time a failure will occur and what maintenance task to perform to correct the failure. As such, the user can plan when they want to perform maintenance on the GC system instead of having a failure and/or maintenance issue occur in the middle of a sample run or analysis. This provides both time and cost savings because it avoids having to re-run the sample due to an unexpected failure that occurred part of the way through the sample analysis.

Another advantage of the diagnostic and predictive module 118 is the ability to continuously monitor instrument health and chromatographic performance over time (e.g., over a number of sample injections or a certain amount of instrument run time). As discussed above, the diagnostic and predictive module 118 utilizes chromatographic performance monitoring, chromatographic modelling, and the automated GC troubleshooting procedure to enable the GC system 100 to dynamically monitor its own functionality, predict future chromatographic performance and/or maintenance issues, and automatically suggest certain maintenance tasks to perform. Following the performance of a maintenance task, the diagnostic and predictive module 118 also enables the GC system 100 to compare chromatographic performance to an ideal chromatogram to automatically confirm that chromatographic performance has returned to an acceptable baseline performance level.

For example, incorporating troubleshooting with the ability to compare current chromatographic performance to a reference chromatographic separation enables the GC system 100 to automatically confirm results after maintenance is performed. As such, the user can quickly determine whether performance of the GC system 100 has returned to an acceptable initial baseline. Additionally, incorporating chromatographic modelling with the comparison of current chromatographic performance and reference chromatographic separations further improves the confirmation of results following maintenance because it enables the comparison of real-time collected data of the GC system with a theoretical data set. Incorporating chromatographic modelling with the comparison of current chromatographic performance and reference chromatographic separations further enables users to troubleshoot instrument performance and/or maintenance issues without a previous “known good” reference (e.g., during analysis of a sample that has never been run on the GC system or issues encountered during instrument installation).

### Chromatographic Performance Monitoring

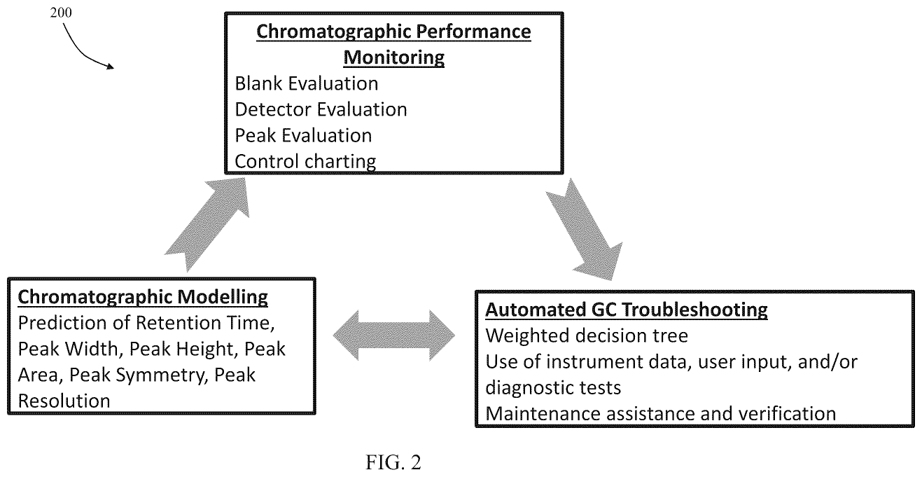

As discussed above, and illustrated in FIG. 2, the diagnostic and predictive module 118 includes software and/or firmware 200 that combines chromatographic performance monitoring, chromatographic modelling, and the automated GC troubleshooting procedure, to provide additional functionality of the GC system 100 compared to separately using chromatographic performance monitoring, chromatographic modelling, and the automated GC troubleshooting procedure. In various embodiments, chromatographic performance monitoring includes performing certain performance evaluations of the GC system 100 such as a blank evaluation, a detector evaluation, and/or a peak evaluation to determine if the GC system 100 is performing properly (i.e., analysis results are within specified control limits or thresholds). For example, the diagnostic and predictive module 118 may execute a blank evaluation utilizing sample data collected during one or more blank runs (i.e., analysis where no analytes are present) to analyze a baseline chromatographic performance of the GC system 100. During the blank evaluation, the diagnostic and predictive module 118 determines the presence or absence of any carryover material by determining if a baseline signal, noise, and combined peak area over a selected time window falls outside pre-defined thresholds (e.g., user defined control limits or instrument defined control limits).

In another non-limiting example, the diagnostic and predictive module 118 may execute a detector evaluation which utilizes a specified sample to confirm the detector performance by comparing peak retention times, peak areas, and peak height with a set of reference values and/or limits that have been deemed by the manufacturer to represent nominal performance.

In yet another non-limiting example, the diagnostic and predictive module 118 utilizes peak evaluation to compare sample data of a current sample being analyzed by the GC system 100 with a previously defined reference chromatogram. More specifically, peak evaluation utilizes the reference chromatogram, or alternatively or additionally a simulated chromatogram generated from a chromatographic model of the GC system, to define certain expected chromatographic parameters, such as but not limited to, retention time, relative retention time, retention index, adjusted retention time, peak height, peak area, peak width, peak symmetry, peak resolution, peak capacity, skew, kurtosis, Trennzahl, capacity factor, selectivity, efficiency, apparent efficiency, tailing factor, concentration, and mole quantity, for multiple peaks (e.g., 5 peaks, 10 peaks, 20 peaks, etc.) in the sample. As such, the diagnostic and predictive module 118 evaluates one or more of the chromatographic parameters of the current sample being analyzed via comparison to the reference chromatogram and/or simulated chromatogram to indicate whether the GC system 100 is performing properly. For example, the reference chromatogram and simulated chromatogram can provide a nominal chromatographic performance, and the GC system 100, or the user of the GC system 100, can define a set of control limits based on the nominal chromatographic performance. Thus, the diagnostic and predictive module 118 evaluates the one or more chromatographic parameters of the sample data to determine if the one or more chromatographic parameters exceed the set of control limits.

In various embodiments, chromatographic performance monitoring can utilize chromatographic modelling in place of the reference chromatogram to identify chromatographic performance issues. More specifically, if there is no known good reference chromatogram, the nominal chromatographic model described below can be used for the baseline comparison to determine the expected chromatographic performance of the GC system. For example, if the user does not have a reference chromatogram for a sample to be analyzed by the GC system, the user may input the analytes of the sample and the GC system generates the nominal simulated chromatographic separation of the sample using the setpoints as inputs into the model. In another embodiment, chromatographic modelling can be used to verify the reference chromatogram. For example, a chromatogram generated from a nominal chromatographic model or a model using the instrument data obtained while generating the reference chromatogram may be compared to the reference chromatogram to determine if the reference chromatogram represents acceptable GC system performance.

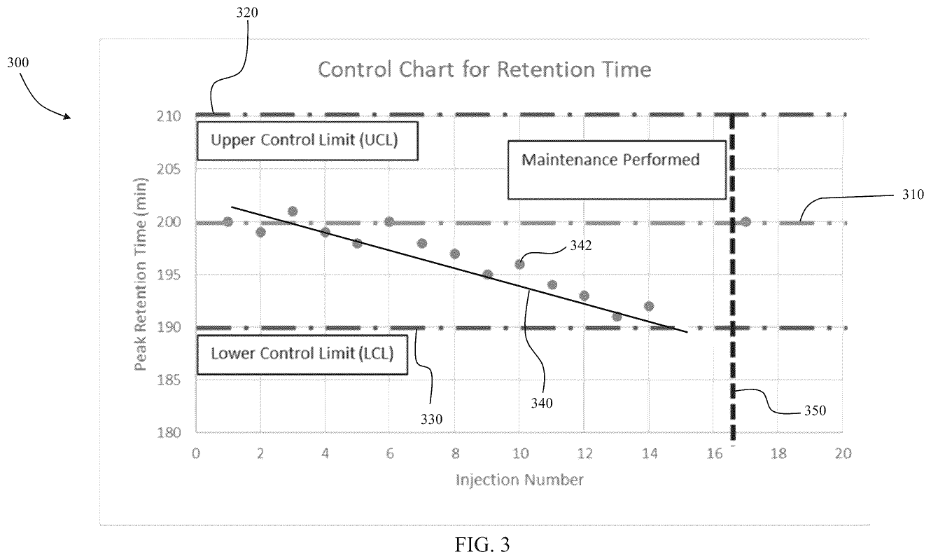

The chromatographic performance monitoring of the diagnostic and predictive module 118 can also utilize control charting (e.g., control chart 300 of FIG. 3) to track and communicate any discrepancy between expected chromatographic parameters, and sample data of the analyzed sample, and predict when this discrepancy will exceed control limits. For example, the diagnostic and predictive module 118 utilizes the reference chromatogram and/or simulated chromatogram generated from a model of the chromatographic system as described below to determine an expected chromatographic value (e.g., retention time) and applies control limits defined by either the GC system 100, or the user, as a tolerance band of the nominal or expected chromatographic value. These control limits may be defined as an absolute value or a percentage of the expected chromatographic value. During sample analysis, the diagnostic and predictive module 118 extrapolates the expected chromatographic values to predict if and/or when the chromatographic parameter may fall outside of the control limits.

In some embodiments, the diagnostic and predictive module 118 generates the control chart 300 including data associated with monitoring the peak retention time of a specific analyte being analyzed by the GC system 100. As shown, the control chart 300 illustrates that the specific analyte being analyzed by the GC system 100 has an expected retention time 310 of 200 minutes, an upper control limit 320 of 210 minutes and a lower control limit 330 of 190 minutes. In the illustrated example embodiment, during sample analysis the actual retention time of the analyte is recorded after each sample injection. The diagnostic and predictive module 118 analyzes the actual retention time data (e.g., using a linear or non-linear regression) to determine a retention time trend line 340 based on peak retention time points 342 of control chart 300. In the illustrated example, the peak retention time points 342 are plotted against each sample injection number. As such, the retention time trend line of 340 would show that for each sample injection the peak retention time decreases at a predictable rate. More specifically, retention time trend line 340 shows that the expected retention time will exceed the lower control limit 330 on the 15^{th} sample injection. As such, the diagnostic and predictive module 118 generates and transmits a warning message to the user that the peak retention time will fall outside of the lower control limit 330 on the 15^{th} sample injection.

Additionally or alternatively, control charting may be used by the diagnostic and predictive module 118 to monitor certain instrument data collected by instrument sensors (e.g., sensors 111 of FIG. 1) such as temperature values, pressure values, valve states, motor steps, syringe injection counts, motor current, heater current, heater duty cycles, flow sensor values, detector signal levels, detector current levels, time on values, valve duty cycles, and other such instrument sensor values. In such embodiments, the diagnostic and predictive module 118 control charts the instrument data to predict possible failures of the GC system 100 that could not otherwise be predicted. That is, without the diagnostic and predictive module 118 monitoring certain instrument data, sample data and/or chromatographic performance values, it would be very difficult to determine a performance and/or maintenance issue before a failure of the GC system occurred. The nominal values and control limits for the instrument data may be determined from setpoints, average values and standard deviations on these values determined in the factory, instrument data collected while generating the reference chromatogram, or other means.

An example of this use would be if the split vent trap on the exit of the injection port starts to become clogged while the user is injecting samples. This may occur if a user is injecting dirty samples which clog the split vent trap incrementally with each injection. This will eventually cause an additional restriction in the system, resulting in the duty cycle of the split vent valve that controls the flow through the split vent trap to decrease to compensate for the new restriction (leaving the valve more “open”) while maintaining the same flowrate and, therefore, split ratio (i.e. the ratio of flow through the column to flow through the split vent trap). Initially, the actual split ratio will not change (and therefore the user will obtain the same chromatographic results), but over time the duty cycle of the split vent valve will continue to decrease. This issue will not affect chromatographic results until it has progressed significantly, but if the system is monitoring the duty cycle of the split vent valve (through control charting) any decrease in valve duty cycle will be noticed by the instrument. Detecting the issue at an early stage is helpful to the user, because eventually the split vent valve will open all the way and the restriction will cause an increase in the inlet pressure, thus causing a difference between the actual split ratio and the user's desired split ratio. This change in split ratio will cause incorrect chromatographic results and compromise the user's data, eventually leading to a failed peak evaluation result due to increased peak area. By utilizing control charting, the user will be notified of this decrease in split vent duty cycle well before any chromatographic issues arise, thus allowing the user to take action before any samples (or results) are compromised. As such, utilizing the diagnostic and predictive module 118 to dynamically monitor certain instrument data enables the GC system to predict when a failure may occur instead of waiting to notify the user after a failure has been detected. If the user continues to run further analyses rather than performing maintenance, the change in split ratio and attendant changes in chromatography will also be flagged by the instrument through automated comparison of the real-time simulated chromatographic separation (which uses instrument actual values for temperature and pressure setpoints as inputs to the chromatographic model as described below) and the nominal simulated chromatographic separation (which uses method setpoints as inputs to the chromatographic model as described below) as analyses continue to be performed. This allows the user a further opportunity to troubleshoot and perform maintenance before their chromatographic results become poor enough to fail peak evaluation.

### Chromatographic Modelling

As discussed previously, the diagnostic and predictive module 118 combines chromatographic performance monitoring, chromatographic modelling, and the automated GC troubleshooting procedure to dynamically monitor the chromatographic performance and functionality of the GC system 100. In various embodiments, the diagnostic and predictive module 118 utilizes chromatographic modelling to determine performance data and certain expected chromatographic parameters, such as the retention time, relative retention time, retention index, adjusted retention time, peak height, peak area, peak width, peak symmetry, peak resolution, peak capacity, skew, kurtosis, Trennzahl, capacity factor, selectivity, efficiency, apparent efficiency, tailing factor, concentration, and mole quantity of the sample or analyte being analyzed by the GC system 100. For example, chromatographic modelling utilizes the instrument configuration, the instrument setpoints of the chromatographic method of sample separation, and, in some embodiments, real-time instrument data to simulate the chromatographic separation of the sample being analyzed by the GC system 100. That is, the chromatographic model utilizes the physical characteristics of the GC system 100 such as, carrier gas type, column dimensions, detector parameters, inlet pressure, outlet pressure, and temperatures, coupled with analyte-column specific thermodynamic properties to simulate the chromatographic separation of the sample or analyte. The simulated chromatographic separation can be used to determine the expected retention time, peak width, and/or other such chromatographic parameters of the sample being analyzed by the GC system 100.

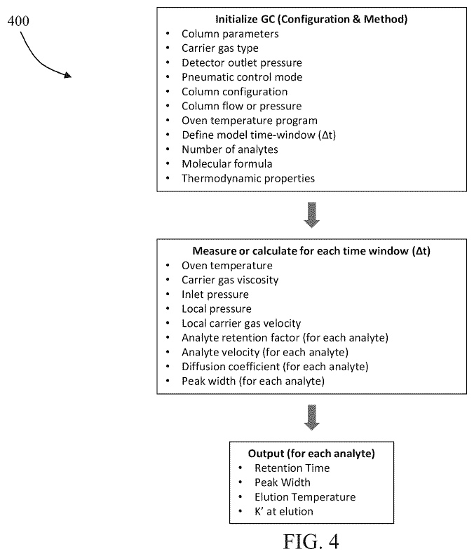

Referring now to FIG. 4, the diagnostic and predictive module 118 executes a chromatographic modelling application 400 to generate the chromatographic model. As such, prior to generation of the simulated chromatographic separation, a user of the GC system 100 determines a GC system configuration that initializes certain parameters for the diagnostic and predictive module 118. For example, the diagnostic and predictive module 118 initializes and/or defines the following parameters from the GC system configuration: the column parameters (e.g., length, inner diameter, stationary phase thickness, stationary phase type); the carrier gas type; the column and/or detector outlet pressure; the pneumatic control mode (flow or pressure); the pre-determined time window (Δt); the column heater temperature heating rate(s) and/or isothermal holds (for determining nominal temperature calculation at each pre-determined time window); and the desired column flow rate and/or pressure. It should be appreciated that other parameter values of the GC system 100 may be utilized by the diagnostic and predictive module 118.

In various embodiments, the chromatographic modelling application 400 utilizes a time-based, iterative model to mathematically simulate the GC separation of the sample in a similar fashion to that of Snijders, H. et. al. (Journal of Chromatography A, 718, 1995, p. 339-355). The chromatographic modelling application 400 simulates the complete GC separation as a collection of many short isothermal separations using a pre-defined time window (Δt). Within each pre-defined time window (Δt) the retention factor (k′) of each analyte is calculated using analyte-column specific thermodynamic values derived from Van't Hoff data along with other instrument data. The analyte velocity is then calculated from the retention factor and the distance the analyte travels within each At can be calculated from the analyte velocity and the pre-defined time window (Δt). During the each segment of the simulation, the chromatographic modelling application 400 performs a series of calculations of relevant chromatographic equations until certain numerical thresholds are met (e.g., when the total analyte travel distance exceeds the column length). The chromatographic modelling application 400 can generate an expected retention time, peak width, peak height, peak area, and peak symmetry for analytes in the sample as defined by the user.

In various embodiments, the chromatographic modelling application 400 utilizes method setpoints from the GC system 100 as inputs to the chromatographic model to generate what is referred to as a nominal simulated chromatographic separation. The GC controller 110 can be instructed by the user of the GC system 100 to define certain method setpoints to be used. In some embodiments, the column heater temperature and the inlet pressure are two setpoints set by the user. The chromatographic modelling application 400 will use these setpoints when performing the requisite calculations during each pre-defined time window (Δt). This model represents what the user expected the instrument to do based on the setpoints entered by the user. It should be appreciated that other instrument parameter setpoints of the GC system 100 may be utilized by the chromatographic modelling application 400. Alternatively, the nominal simulated chromatographic separation could be generated by using instrument data collected while generating the reference chromatogram as inputs to the chromatographic model.

In various embodiments, another type of chromatographic model generated by the chromatographic modelling application 400 utilizes real-time instrument data (e.g. column heater temperature values, inlet pressure sensor values, etc.) as measured and/or determined by the GC system 100 during a chromatographic analysis to generate the simulated chromatographic separation of the chromatographic model. As such, the real-time generated chromatographic model provides several advantages over other models utilizing nominal or ideal setpoints. More specifically, by using real-time instrument data, the chromatographic model generated by the diagnostic and predictive module 118 precisely reflects what the GC system 100 was actually doing during the sample separation, not what the system was assumed to be doing. For example, air currents and/or heat sinks around thermal zones of the GC system can alter the actual zone temperature compared to the zone temperature setpoint. Additionally, barometric pressure fluctuations can alter the outlet pressure of the column and change the velocity of gasses within the column during the actual sample separation compared to the assumed velocity of gasses of a nominal or ideal separation. As such, the accuracy of the chromatographic model is improved by utilizing real-time instrument data instead of setpoints or ideal instrument data. It should be noted that the real-time instrument data collected during the chromatographic separation could be saved for later use. For example, real-time instrument data from a prior chromatographic separation can be saved and then used as the input to generate the simulated chromatographic separation of the chromatographic model after completion of the chromatographic separation, thus replicating the chromatogram that was collected, but doing so in an offline fashion.

### Automated GC Troubleshooting

As discussed above, the diagnostic and predictive module 118 combines chromatographic performance monitoring, chromatographic modelling, and the automated GC troubleshooting procedure to dynamically monitor the chromatographic performance and functionality of the GC system 100. In various embodiments, after the user has been alerted of a chromatographic performance and/or instrument issue, the automated GC troubleshooting procedure guides the user through diagnosis and repair of the GC system 100. Thus, “automated” troubleshooting does not exclude human involvement, but rather includes troubleshooting facilitated by automated steps. Typically, upon failure of the GC system 100 the user must analyze the data and determine on their own what the issue is and what repair(s) are needed to correct the issue. However, the diagnostic and predictive module 118 of the present disclosure guides the user through the troubleshooting and maintenance of the GC system 100.

In some embodiments, the automated GC troubleshooting procedure may take the form of a decision tree. The decision tree can involve a series of questions or observations to guide the user to the most likely maintenance item that will fix the observed or predicted issue. In some embodiments, the automated GC troubleshooting procedure uses the results of chromatographic performance monitoring (i.e. what chromatographic parameter went outside the control limits, did it exceed the lower or upper control limits, did any instrument data fall outside of control limits, etc.) to determine a starting point for the automated GC troubleshooting procedure. For example, if the retention time of one or more peaks was observed to fall outside of the control limits as determined by chromatographic performance monitoring, the automated GC troubleshooting procedure might begin by asking questions or gathering information stored in the system related to causes of a retention time shift of an analyte.

Some of the questions in the decision tree may be presented to the user for input. These may include items that the GC system cannot answer or may include items that the GC system would like the user to verify. As an example, the user may answer questions to verify the configuration of the different modules/method parameters installed on the instrument The user may verify items (e.g. the column type and dimensions, the syringe size, sample locations, etc.) to confirm that the system is correctly configured for the analysis being performed.

In addition to questions posed to the user for input and/or verification, the system may also guide the user to different branches of the decision tree based on the chromatographic performance monitoring results, instrument data, simulated chromatographic separation(s), and/or diagnostic tests. In other words, the user may not need to answer all of the questions in the decision tree since the GC system is able to access information stored internally or gather additional information by initiating diagnostic tests. In some cases, the user would not have access to this information, thus enhancing the ability to perform troubleshooting over what an individual user could do without the automated GC troubleshooting procedure.

For example, chromatographic performance monitoring could be used to answer the question ‘Are the retention times shorter or longer?’ by comparing the peaks in the sample chromatogram from the most recent analysis to that of the reference chromatogram and/or simulated chromatogram. It could also determine if the retention time for more than one analyte was shorter or longer or if the issue only affected one of the analytes in the sample by using additional information being monitored by peak evaluation. If the retention time of only one analyte was affected, it might guide the user to a portion of the decision tree associated with issues with the inlet, whereas if the retention time of more than one analyte is affected, it might begin to ask questions or gather information to investigate issues with the column heater.

Instrument data can verify that the setpoints matched the actual values achieved during the chromatographic analysis. Whether or not they match can guide the decision tree to different branches. For example, if the setpoint for the column heater temperature was ramped at a rate that the instrument could not achieve, the system could analyze the deviation between the instrument data for the analysis and the setpoint and determine that the temperature was lower than expected and could be the cause of retention times being longer than anticipated. A similar methodology could be used for other instrument data such as, but not limited to, temperature values, pressure values, valve states, motor steps, motor current, heater voltage, heater duty cycles, flow sensor values, detector signal levels, detector current levels, time on values, valve duty cycles, and other such instrument sensor values.

Certain diagnostic tests could be run by the GC system with or without user assistance to guide the decision tree. For example, if the user had the issue of “no peaks” in the chromatogram because of a leak located in the inlet septum, the GC system can guide the user through the decision tree by accessing internally stored information and/or automatically running diagnostic tests as needed. Using information stored on the GC system and automatically running diagnostic tests provides for a better user-experience with less questions asked to the user during troubleshooting. For the example described below, the user will have the issue of “no peaks” in the last chromatogram they collected, with the root-cause issue being a leak located in the inlet septum. An alert informs the user of a failed peak evaluation, identifying the issue as no peaks found in the chromatogram.

The automated GC troubleshooting procedure will be initiated with the GC symptom of “no peaks.” The user could be asked a series of questions (or be asked to perform a task) about the issue they are having to determine the root-cause of the chromatographic issue they are observing. Some of the tasks a user may be asked to complete is looking for a leak within the flowpath of the GC or verifying the FID jet is not clogged. The skills of the user may determine the quality of the results and information provided to the GC system, which therefore will dictate how well the instrument can determine the root-cause of the chromatographic issue. With the automated GC troubleshooting procedure, the user will be assisted by the GC system answering some of these questions without user interaction.

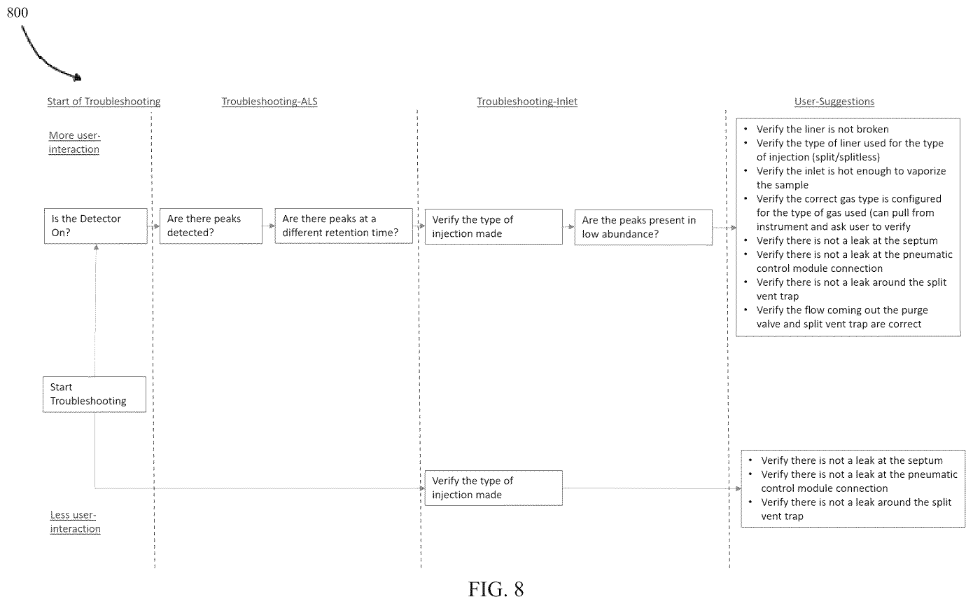

FIG. 8 shows process or steps 800 a user takes with troubleshooting the issue of “no peaks” leading to the solution of a leak in the inlet septum. The top portion of FIG. 8 demonstrates the user-interaction if troubleshooting does not use information from the GC system or automatically perform diagnostic tests. The bottom of FIG. 8 shows the user-interaction if troubleshooting uses information from the GC system and performs automated diagnostic tests. For the above example, if the issue of “no peaks” was caused by a leak in the inlet, the user would normally be required to answer five questions from the user-guided decision tree to arrive at the suggested or expected maintenance task. With the automated GC troubleshooting procedure using information stored on and/or gathered by the GC system, the user will only have to answer one question related to verifying the type of injection made (e.g. split, splitless, etc.). After the user verifies the type of injection made, the GC system then runs the leak and restriction diagnostic test. The leak and restriction test will first verify the inlet control by holding the inlet at a pressure setpoint. Next, it will start to monitor the error between the actual flow and targeted setpoint column flow. If there is a leak present at the inlet septum, the system will detect greater flow than what is needed by the column and determine there is a leak present in the system. Based on this information, the automated GC troubleshooting procedure could tell the user there is a leak in the GC system flow path and provide them with the following suggestions: 1) Replace the septum, 2) Reinstall the column, 3) Replace the liner and liner O-ring, and 4) Open the split vent trap and check the O-ring seating. Replace the split vent trap if needed. If the instrument does not automatically perform the leak and restriction test, the user will be supplied with a much larger list of potential issues to check and fix (e.g. 8 possible solutions).

Another aspect of troubleshooting is the ability for the GC system to store and use information about recent maintenance tasks or hardware changes that may have occurred. If the GC system was previously performing correctly, there is a greater probability the issue is in the area where the user recently made a change. By using maintenance information stored on the GC system, the user will be provided a direct route to a solution that has a higher probability of correcting the issue that is occurring. An example is if the user recently performed inlet maintenance (such as changing the inlet septum), the automated GC troubleshooting procedure will use this recent maintenance information stored on the GC system and guide the user to start in the inlet section of the decision tree.

In various embodiments, chromatographic modelling can be used by the automated GC troubleshooting procedure to determine certain maintenance tasks that may correct the chromatographic performance issues. For example, if the nominal and real-time simulated chromatograms and the reference chromatogram agree with one another but the experimental sample chromatogram of the current sample run does not agree with the simulated chromatograms and reference chromatogram, the automated GC troubleshooting procedure may determine that the GC system was controlling as expected but something that the GC system, and therefore, the GC model, is unaware of may have changed. That is, the thermal and pneumatic setpoints were in control during the sample run and something outside of the GC system control and knowledge may have changed to cause the chromatographic performance issue (e.g., wrong sample injected, column trimmed and parameters not updated, column is starting to fail, etc.). As such, the automated GC troubleshooting procedure may proceed to portions of the decision tree that instruct the user to confirm whether any changes have been made to the GC system, confirm that the configuration is correct, or investigate performance issues related to column degradation, flow path contamination, etc.

In another example, if the real-time simulated chromatogram and the experimental sample chromatogram of the current run match but the reference chromatogram and/or nominal simulated chromatogram does not match the real-time simulated chromatogram and experimental sample chromatogram, the automated GC troubleshooting procedure may determine the GC system was not controlling as expected. For example, certain sensor values may not match the setpoints (i.e., column heater temperature does not match the setpoint, inlet pressure sensor does not match setpoint, or expected gas flow does not match setpoint). In these cases, the actual instrument data from the current analysis is used in the real-time chromatographic model and any effect of the instrument data not matching the setpoints would be apparent in the real-time chromatographic model results. As such, the automated GC troubleshooting procedure may guide the user to a part of the decision tree to further investigate components of the GC system, such as heaters, flow control modules, or other components. Diagnostic tests could be implemented to further narrow down the issue and/or confirm an issue. Additionally or alternatively, the automated GC troubleshooting procedure may recommend replacement or servicing a piece of hardware of the GC system (e.g. cleaning, adjusting, etc.) or changing a setpoint as the most likely maintenance item to fix the issue.

In yet another example, the chromatographic model can be compared to itself. That is, a nominal simulated chromatographic separation generated when the GC system is in a known good state and/or using instrument setpoints is compared with the real-time simulated chromatographic separation. Thus, if the nominal simulated chromatographic separation and the real-time simulated chromatographic separation do not match, the automated GC troubleshooting procedure may determine that there is a GC system hardware issue. For example, if the real-time simulated chromatographic separation shows longer analyte retention times than the nominal simulated chromatographic separation, this may suggest that the flow rate or temperature are lower than expected. The automated GC troubleshooting procedure may suggest that a flow path cold spot, a flow path leak, or other such flow path issue may be the cause of the longer retention times. In such an example, the GC system configuration (i.e., column type/dimensions, gas types, etc.) is the same for the real-time chromatographic model and the nominal chromatographic model but the real-time chromatographic model utilizes actual thermal and pneumatic values of the GC system. Thus, the real-time simulated chromatographic separation would differ from the nominal simulated chromatographic separation if the thermal and/or pneumatic values differ.

For example, if the user inputs a column heater ramp rate into the GC system that the system cannot meet, the nominal simulated chromatogram can be generated based on the setpoints (i.e. expected ramp rate). However, the real-time simulated chromatogram will be generated using the actual column heater temperature values and the column heater temperature will be colder than expected because it cannot meet the expected temperature ramp rate. Thus, the real-time simulated chromatogram will not match the nominal simulated chromatogram because the nominal model uses a faster ramp rate. Based on the chromatographic modelling results, the system could use the instrument data (e.g. measured thermal values) to compare against the expected thermal setpoint values input by the user. In this example, the column heater temperature may not have been close to the setpoint value, and the system could inform the user that the desired column heater ramp rate was not achieved. This would be beneficial if a user does not realize the column heater ramp rate is not actually being achieved. If the user generated a reference chromatogram using the unachievable ramp rate, their ‘known good’ chromatogram wasn't collected with expected setpoint values and thus may not expose the issue. Additionally, if a user entered an oven temperature ramp rate that the GC can achieve, but for some reason was unable to in a sample run, this could indicate a hardware error and the diagnostic and predictive module 118 could indicate the column heater is not functioning as expected.

In various embodiments, the automated GC troubleshooting procedure can also utilize chromatographic modelling to verify that an expected maintenance task will successfully correct the chromatographic performance issue before performing the maintenance task. More specifically, the simulated chromatographic separation can be generated prior to performing the maintenance task if the user and/or the GC system knows what changes will be made during the maintenance task and the model can use the instrument setpoints as inputs. For example, the user may have been trimming their column periodically to eliminate contamination. Each time the user trimmed the column, they may have updated the new length in their instrument configuration. If chromatographic performance monitoring finds that the retention time has now shifted outside of the established limits due to the column being shorter, the automated GC troubleshooting procedure may suggest replacement of the column to correct or otherwise fix the chromatographic performance issue. The chromatographic model can utilize the column dimensions, phase type, and other such parameters of the new column to verify that replacing of the column will correct or otherwise fix the chromatographic performance issue.

In some embodiments, after being guided through the automated GC troubleshooting procedure, a single maintenance task or a list of more than one weighted or ranked possible maintenance tasks will be provided to the user. These maintenance tasks may be weighted or ranked depending on the answers provided from the user or from diagnostic tests that were performed by the instrument during the automated GC troubleshooting procedure based on the likelihood that each may fix the current performance issue. Users will then be provided with guidance to perform the maintenance task that was suggested. After the user has performed the maintenance task, the ability to make a verification run will be suggested to verify that the maintenance tasks fixed the original chromatographic issue. If the suggested maintenance task resolved the user's chromatographic issue, they will have the option to update the reference chromatogram and proceed with normal instrument operation. If the suggested maintenance task did not resolve the user's chromatographic issue, they will have the option to go through automated troubleshooting again or be provided with additional support information (such as manufacturer contact information).

In various embodiments, the diagnostic and predictive module 118 utilizes chromatographic performance monitoring, chromatographic modelling, and the automated GC troubleshooting procedure, combined with machine learning and/or a neural network to configure the diagnostic tool to predict the timeframe and failure mode of instrument performance and/or maintenance issues before they occur. For example, the diagnostic and predictive module 118 can utilize a neural network to rank and order a plurality of different maintenance tasks associated with potential chromatographic performance and/or maintenance issues of the GC system 100. That is, the neural network can analyze chromatographic performance monitoring data, instrument data, data from diagnostic tests, and/or a simulated chromatogram to correlate the data with the plurality of different maintenance tasks. As such, the diagnostic and predictive module 118 utilizes the neural network to assign a weight or rank of each of the different maintenance tasks based on a likelihood of the maintenance task fixing the instrument performance and/or maintenance issue.

In various embodiments, the diagnostic and predictive module 118 can also incorporate machine learning to teach the GC system 100 that certain sample data and/or instrument data is associated with a particular failure or maintenance issue of the GC system 100 or with a limited number of likely issues. That is, the diagnostic and predictive module 118 can analyze past chromatographic performance monitoring results, sample data, instrument data, data from diagnostic tests, and/or simulated chromatograms with different performed maintenance tasks to correlate instrument failure and performed maintenance. As such, the diagnostic and predictive module 118 can learn that certain sample data and/or instrument data indicate one or more failures or maintenance issues of the GC system 100. Thus, over time the GC system 100 learns, based on past GC system troubleshooting and maintenance, that certain chromatographic performance monitoring results, sample data, instrument data, data from diagnostic tests, simulated chromatograms and/or combinations thereof can indicate certain failure modes of the GC system 100.

Another aspect of troubleshooting is the use of a neural network and/or machine learning process to help guide the user through the decision tree. Utilizing a neural network and/or machine learning process will aid the GC system in learning what repeated issues have occurred and the associated solutions that were used to fix these issues. An example of this is if the user repeatedly has the same issue occurring, such as a leak at the inlet septum. If the neural network and/or the machine learning process of the GC system notices a pattern of this leak continuing to occur, the GC system will first have the user check the inlet for leaks instead of walking the user through the entire decision tree process. This will reduce the amount of questions asked to the user from the instrument, and provide the user with a direct route through the decision tree and to a solution that has previously worked to correct the issue.

Another advantage of the GC system utilizing a neural network and/or machine learning process, is the GC system's ability to suggest other possible solutions if the same issues continue to repeatably arise for the user. An example of this is again if the inlet continues to have a leak located at the inlet septum. If this same issue continues to occur, the GC system may start to suggest other solutions to fix the root-cause of the issue. For the example of a leak repeatedly located in the inlet septum, the GC system may suggest having the user check the syringe to verify a burr is not present in the needle. A burr in the syringe needle will cause the issue of a leak in the septum to repeatably occur but might not be noticed by the user or troubleshooting if the user was just answering questions from the decision tree. By the instrument utilizing a neural network and/or machine learning, the instrument can provide greater insight to the user and determine the root-cause of this issue.

Once the maintenance task is complete, the diagnostic and predictive module 118 records and indicates that maintenance has been performed (e.g., maintenance indication line 350 on control chart 300 of FIG. 3). The automated GC troubleshooting procedure then instructs the user to perform a verification run using the same sample and separation process to verify the chromatographic performance and/or maintenance issue has been corrected. Results from the verification run will be compared back to the previous reference chromatogram and/or chromatographic model to see if the results match. If the verification run results match the previous reference chromatogram and/or simulated chromatogram, the reference chromatogram will be updated, and the instrument will go back to normal operation. If the verification run results do not match the previous reference chromatogram and/or simulated chromatogram, the user will go back through the automated troubleshooting to determine the cause of the issue they are having. Users will also have the ability to accept or reject the verification run results and go back to the automated troubleshooting if they choose. Users may also accept verification run results even if they do not match the results of the chromatographic model but match their previous reference chromatogram. Control charts could be updated, reinitialized, and/or cleared where appropriate if the issue is determined to have been fixed.

### EXAMPLE 1

There exists a wide range of chromatographic analysis methods that have been developed to understand, both qualitatively and quantitatively, the constituents of complex sample matrices. There are many governing bodies, such as ASTM, NIST, and the EPA that design and provide methods for the analysis of a variety of samples. These methods often include complex method setpoints that have been developed to obtain the desired chromatographic results. Some methods aim to quantify analytes with very low concentration (i.e. parts-per-billion), while the goal of other methods may be to quantify compounds at very high concentration levels (percent level). Some methods employ a combination of isothermal and temperature programmed setpoints to separate both volatile and semi-volatile compounds. Other methods may use complex inlet temperature programs or inlet flow dynamics to vaporize thermally labile analytes.

The sheer number of combinations of different chromatographic method parameters makes understanding all the different possible interactions very difficult to decipher when a problem arises. Often, users of a GC system are utilizing methods that have been developed elsewhere and the user may not know why the method setpoints were chosen to be what they are. One of the goals of the development of the diagnostic and predictive module 118 described herein is to assist users in navigating the complex landscape of chromatographic troubleshooting by assisting in not only determining when a problem occurs but also in pinpointing where the problem lies when an issue arises. The goal is to aid in quickly determining the problem and getting the users back up and running as quickly as possible. One of the powerful features is how chromatographic modelling can be used to show the users what the expected behavior of the system should be, without requiring the user having previous knowledge or understanding of the chromatography involved.

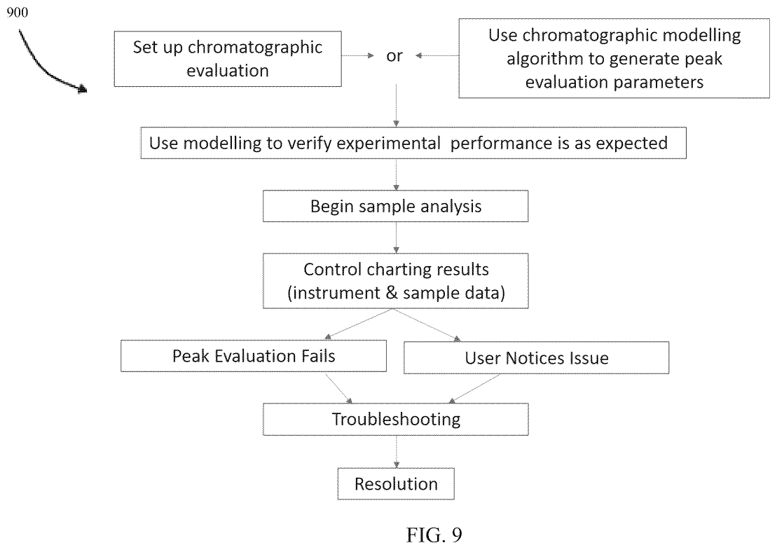

In the following example and referring to FIGS. 1, 3, 4, 5A, 5B, 5C, 6, 7A, 7B, 7C, and 9, a hypothetical analysis method and workflow will be used to highlight and explain the features of the diagnostic and predictive module 118. FIG. 9 shows a flowchart 900 of the process of enabling, configuring, and using the diagnostic and predictive module 118. Prior to starting a sample analysis, the user activates the diagnostic and predictive module 118 to dynamically monitor the chromatographic performance and functionality of the GC system 100. Upon activation of the diagnostic and predictive module 118, the user specifies at least one chromatographic evaluation (e.g., blank evaluation, detector evaluation, or peak evaluation) to utilize to dynamically monitor the chromatographic performance and functionality of the GC system 100. For this example, peak evaluation is used. Peak evaluation enables the user to select which peaks the diagnostic and predictive module 118 will monitor during sample analysis. The user (or the GC system 100) also defines certain peak parameters (e.g., retention time, peak height, peak area, peak width, peak symmetry, and peak resolution), a reference chromatogram, and performance control limits of the sample or analyte to be monitored by the GC system 100. The reference chromatogram may be stored by the GC system 100 or alternatively generated by the GC system 100 before the sample(s) of interest are analyzed. Once the user has specified the peaks to monitor, the chromatographic modelling application 400 will use the GC configuration and method setpoints to generate a simulated nominal chromatogram to verify the GC is performing as expected. The user will then begin running samples as part of their operating procedure. The system will monitor the chromatographic performance and control chart the results. If a problem is detected (e.g. peak evaluation fails or control charting predicts a future problem), the user will then be prompted to begin troubleshooting to diagnose the issue. Once the issue has been resolved, the user can resume analyzing their sample.

In the illustrated example, the analytes chosen are Eicosane (n-C₂₀H₄₂), Docosane (n-C₂₂H₄₆), Tetracosane (n-C₂₄H₅₀), and Hexacosane (n-C₂₆H₅₄). These compounds were chosen to represent a portion of a hydrocarbon analysis, similar to a detailed hydrocarbon analysis (DHA) or a simulated distillation (SIMDIST) where the separation and speciation of different hydrocarbons in the sample is desired. However, it should be noted that there exists a wide range of compounds amenable to analysis by GC and the procedure described herein is not limited to hydrocarbon type samples. In this example, peak evaluation allows the user to track the chromatographic performance of up to 10 peaks in their chromatogram to monitor health and performance of the system. However, it should be appreciated that a greater or lesser number of peaks can be monitored. The relevant experimental parameters are as follows. The column is an 86 m×250 μm×1.5 μm, HP-1 ms with a constant flow rate of 1.0 mL/min using helium carrier gas with an atmospheric pressure outlet. The column heater program started at an initial temperature of 30° C. and was held for 5 minutes, then ramped at 1.5° C./min to a final temperature of 350° C. The detector used was a flame ionization detector (FID). The thermodynamic parameters used for determining the expected retention times in the chromatographic model were collected from a series of isothermal runs to determine the Van't Hoff values.

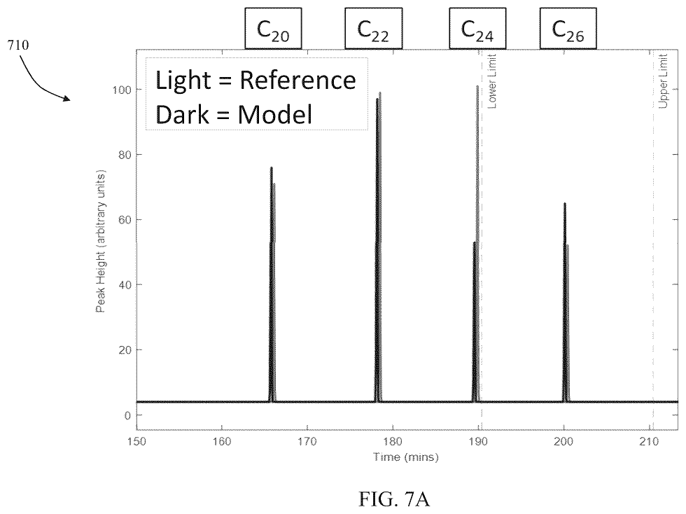

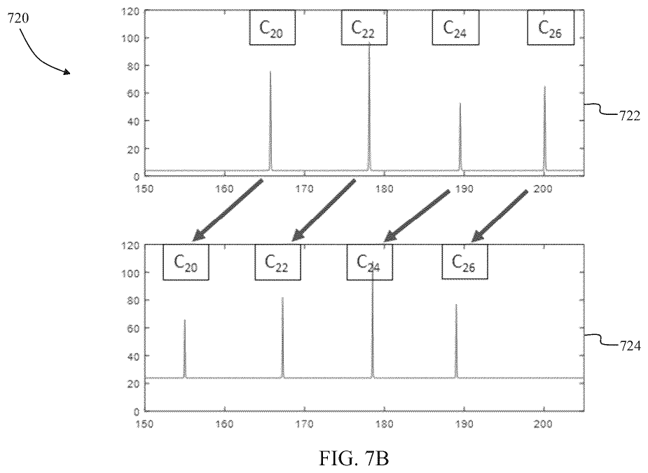

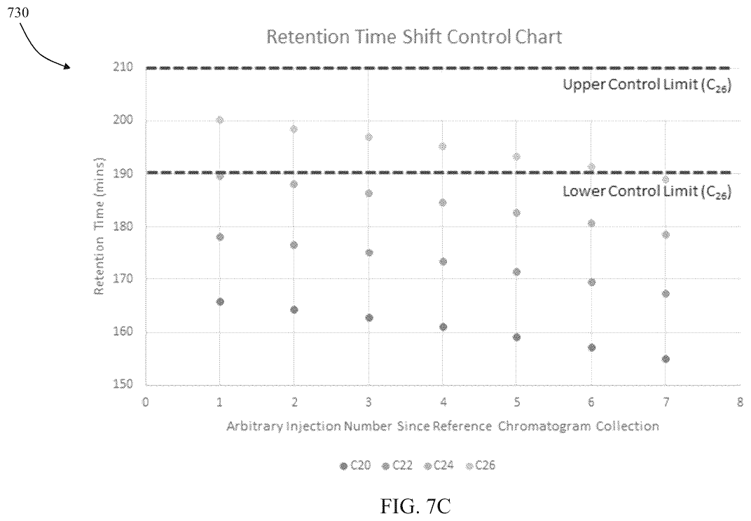

The diagnostic and predictive module 118 utilizes the current GC system configuration and method setpoints to generate the nominal simulated chromatogram. The diagnostic and predictive module 118 then compares the nominal simulated chromatogram with the reference chromatogram. In the illustrated example, the diagnostic and predictive module 118 compares the peak retention time of the reference chromatogram and the nominal simulated chromatogram generated using the nominal chromatographic model and the GC instrument setpoints as inputs into the model. The results are shown below in Table 1 and in overlay chromatogram 710 of FIG. 7A. While the chromatographic model can generate additional chromatographic parameters (peak width, peak area, peak height, peak symmetry), only the retention time is being shown for this example. It should be appreciated that the other chromatographic parameters can be used in a similar fashion.

TABLE 1
Retention time comparison of the Reference
and the Modelled Chromatograms
Experimental Chromatogram vs. Nominal Model
Chromatogram Retention Times (mins)

| | C₂₀ | C₂₂ | C₂₄ | C₂₆ |
|---|---|---|---|---|
| Experimental | 166.07 | 178.45 | 189.85 | 200.43 |
| Nominal | 165.73 | 178.11 | 189.50 | 200.07 |
| Model | | | | |
| % Error | 0.21 | 0.19 | 0.18 | 0.18 |

In the illustrated example, the determined retention time difference or % error between the reference chromatogram and the nominal simulated chromatogram is approximately 0.2%. Such a difference is typical and the diagnostic and predictive module 118 determines the retention time difference or % error between the reference chromatogram and nominal simulated chromatogram is acceptable. It should be appreciated that the simulated chromatogram peak heights as shown in the overlay chromatogram 710 are made lower to better illustrate the matching of retention time of the peaks between the reference chromatogram and nominal simulated chromatogram. As mentioned previously, the modelling results are useful in showing how the instrument in the current configuration and method settings are expected to behave. If the user is unfamiliar with the GC configuration or the analysis, they would have no way to know if the retention times generated from the experimental result are good or not. In this example, the modelling results utilizing the nominal chromatographic model matches the experimental reference chromatogram and the system is deemed to be functioning properly.

Once the GC system 100 is determined to be functioning normally, the user may select a peak evaluation method previously set up for the sample analysis. Alternatively, if a peak evaluation method has not been set up for the sample, the user can input peak evaluation parameters into the GC system and set up a new peak evaluation method. The user may save the method including these input peak evaluation parameters for later use. During sample analysis, the GC system utilizes the peak evaluation method to track and/or monitor chromatographic data (e.g., retention time) of the sample peaks of interest to ensure that the analyte peaks are staying within pre-defined control limits. An example set of peak evaluation parameters is shown below in Table 2. In the illustrated example, the peak evaluation parameters include: the reference chromatogram peak retention time, a retention time limit or % error, and lower and upper control limits for the retention time. The diagnostic and predictive module 118 determines the lower and upper control limits by multiplying the reference chromatogram peak retention times by the retention time limit % error. As such, the lower control limit defines the acceptable limit for a decrease in retention time and the upper control limit defines the acceptable limit for an increase in retention time. In the illustrated example, a +/−5% retention time limit was utilized to determine the lower and upper control limit, however it should be appreciated that different retention time limits can be used. The chromatogram 710 in FIG. 7A shows the upper and lower limits for Hexadecane (C₂₆) as vertical dashed lines at the retention times listed in table 2.

TABLE 2
Peak Evaluation Limits
Peak Evaluation Limits

| | C₂₀ | C₂₂ | C₂₄ | C₂₆ |
|---|---|---|---|---|
| Reference Retention | 166.07 | 178.45 | 189.85 | 200.43 |
| time (mins) | | | | |
| Retention Time Limit | +/−5% | | | |
| Lower Limit (mins) | 155.37 | 169.53 | 180.35 | 190.41 |
| Upper Limit (mins) | 174.37 | 187.37 | 199.34 | 210.45 |

As discussed above, once the user has determined the chromatographic performance is satisfactory and selects the peak evaluation method, the GC system 100 begins running the sample analysis. During the sample analysis, the diagnostic and predictive module 118 executes the peak evaluation to monitor the analyte peak retention times of the sample being analyzed by the GC system 100. As such, upon start of the sample analysis, the diagnostic and predictive module 118 will begin collecting sample data and dynamically control chart the user-defined chromatographic parameters of the sample data. Thus, if during the sample analysis the diagnostic and predictive module 118 determines that one or more user-defined chromatographic parameters will be outside of pre-defined performance control limits (e.g., upper control limit 320 and lower control limit 330) over a certain timeframe (e.g., a specified number of sample injections), the diagnostic and predictive module 118 will notify the user that a user-defined chromatographic parameter (e.g., retention time) will be out of bounds in the near future (e.g. after a number of injections).

As shown in control chart 730 of FIG. 7C, chromatographic performance monitoring of the diagnostic and predictive module 118 generates the control chart 730 that plots peak evaluation results for each analyte peak following each sample injection. In the illustrated example, the control chart 730 evaluates the retention times for the analyte C₂₆. As such, the control chart 730 displays the upper and lower control limits defined in Table 2 for the analyte. It should be noted that the upper and lower control limits exist for all analytes being monitored but is just shown for C₂₆ for clarity. Analysis of the control chart 730 by chromatographic performance monitoring of the diagnostic and predictive module 118 determines that the retention time for the analyte C₂₆ will be near the lower control limit after the sixth sample injection and will exceed the lower control limit after the seventh sample injection. As such, the diagnostic and predictive module 118 can notify the user of the future peak retention time failure and enable the user to utilize the automated GC troubleshooting procedure to correct the peak retention time failure before the failure occurs. In this example, the warning of future retention time failure was ignored, and the system kept running. However, after the 7^{th} injection, the diagnostic and predictive module 118 reports a failed peak evaluation. FIG. 7B shows the original reference chromatogram 722 with expected chromatographic results and the sample chromatogram which failed the peak evaluation 724 showing abnormal results.

In various embodiments, if the user decides to accept troubleshooting assistance, the diagnostic and predictive module 118 collects additional input or information through a series of questions displayed to the user and/or through the use of a simulated chromatogram, instrument data, and/or diagnostic tests. More specifically, the diagnostic and predictive module 118 steps through a user-guided decision tree that utilizes user-provided information (and/or system provided information) to guide the user through troubleshooting of the GC system 100.

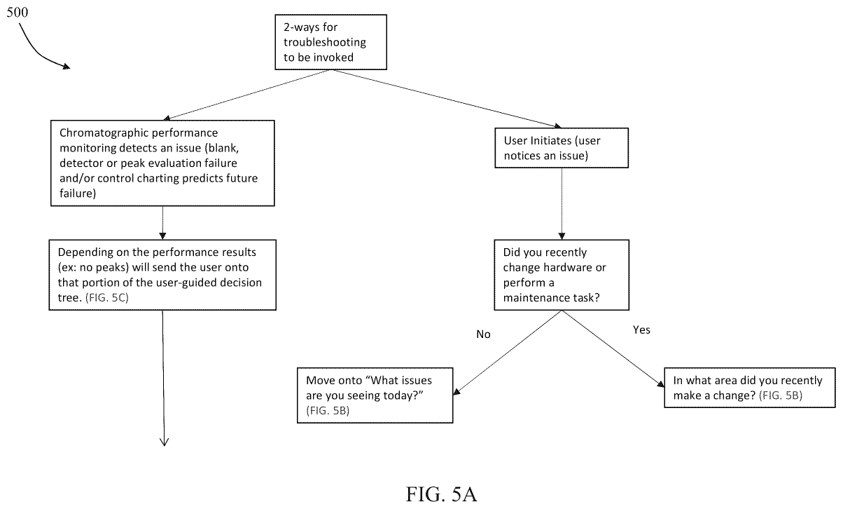

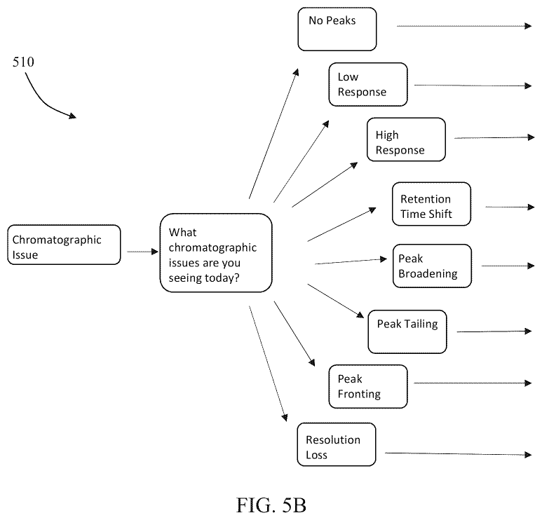

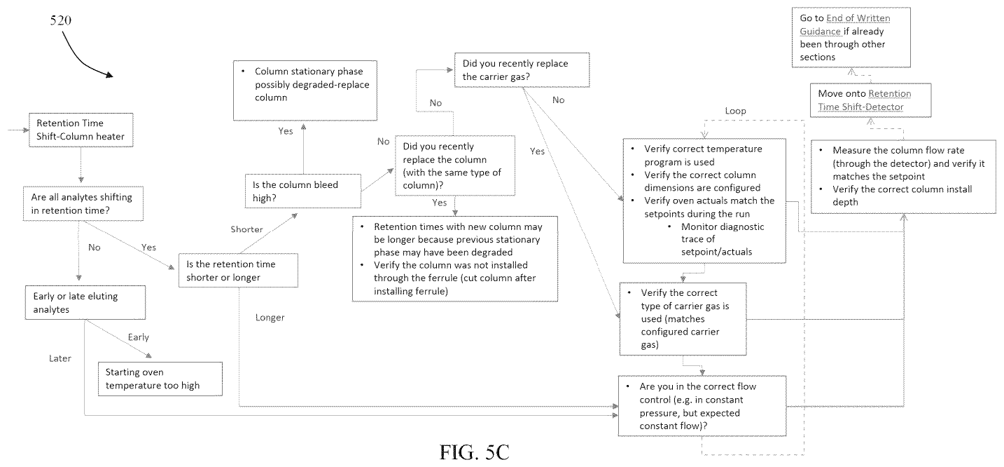

As illustrated in FIG. 5A, weighted decision tree portion 500 illustrates two general ways for the diagnostic and predictive module 118 to begin automated intelligent troubleshooting of the GC system 100. One way that automated GC troubleshooting procedure may begin is when a GC performance issue is detected through chromatographic performance monitoring. For example, as illustrated in the example described here, a GC performance issue based on a peak evaluation failure may be detected if one or more of the user-defined peak data parameters falls outside of the upper or lower control limits or it is determined that it will fall outside the upper or lower control limits in the near future. As such, depending on the performance result, the diagnostic and predictive module 118 will generate and display a message to the user that a performance and/or maintenance issue has been detected and asks the user if they would like troubleshooting assistance. If the user requests troubleshooting assistance the diagnostic and predictive module 118 determines where to begin the guided troubleshooting assistance by using the information from chromatographic performance monitoring. For example, if chromatographic performance monitoring within the diagnostic and predictive module 118 determines that a future failure will occur due to peak retention time falling outside of the control limits, then the automated GC troubleshooting procedure within the diagnostic and predictive module 118 directs the user to a weighted decision tree portion associated with retention time shifts, as illustrated in FIG. 5C.

Referring back to FIG. 5A, a second way that the automated GC troubleshooting procedure may begin is that the user notices some performance issue during the sample chromatographic separation and manually initiates the automated GC troubleshooting procedure of the GC system 100. The user may start troubleshooting a performance issue by accessing a diagnostics tab or other such menu option of the diagnostic and predictive module 118. Once the user initiates troubleshooting of the GC system 100, the diagnostic and predictive module 118 asks the user if they recently changed any hardware and/or performed a maintenance task of the GC system 100. If the user answers that no hardware was changed or no maintenance task was performed, then the diagnostic and predictive module 118 directs the user to weighted decision tree portion 510 to ask the user what chromatographic issues they are seeing today, as illustrated in FIG. 5B. The diagnostic and predictive module 118 then displays multiple different performance issues for the user to choose from such as, no peaks, low response, high response, retention time shift, peak broadening, peak tailing, peak fronting, and resolution loss. It should be appreciated that the diagnostic and predictive module 118 may display other performance issues for the user to choose from. Once the user selects the chromatographic issue they observe, the guided troubleshooting proceeds to the troubleshooting portion associated with that issue.

On the other hand, if the user answers that hardware was recently changed or a maintenance task was recently performed, the diagnostic and predictive module 118 asks the user what recent changes were performed to address the performance issues (e.g., retention time shift) of the GC system 100. The diagnostic and predictive module 118 then directs the user to weighted decision tree portion 510 to ask the user what chromatographic issues they are seeing today, as illustrated in FIG. 5B. The diagnostic and predictive module 118 then displays multiple different performance issues for the user to choose from such as, no peaks, low response, high response, retention time shift, peak broadening, peak tailing, peak fronting, and resolution loss. It should be appreciated that the diagnostic and predictive module 118 may display other performance issues for the user to choose from. Once the user selects the chromatographic issue they observe, the guided GC troubleshooting proceeds to the troubleshooting portion associated with that issue. For example, if the user answered that they recently repaired hardware or performed a maintenance task associated with a retention time shift, then the guided troubleshooting proceeds to weighted decision tree portion 520 to further investigate that issue, as illustrated in FIG. 5C. However, in the illustrated example, no hardware was recently changed.

As discussed above, the diagnostic and predictive module 118 may utilize the automated GC troubleshooting procedure to determine the cause of the peak evaluation failure and what corrective action may be needed. In this example the peak evaluation failed with peaks having shorter retention times that fall outside of the retention time limit, so the ‘Retention Time Shift’ pathway is chosen in FIG. 5B. In this case, the GC is able to determine the correct chromatographic performance failure mode without asking the user. FIG. 5C is the subsequent decision tree following from FIG. 5B. The first two questions, “Are all analytes shifting in retention time?” and “Is the retention time shorter or longer” are determined by the diagnostic and predictive module 118 using information from the chromatographic performance monitoring and/or the reference chromatogram, simulated chromatogram, and/or current sample chromatogram. The next question following that pathway may require user interaction, but in some instances could also be determined by the diagnostic and predictive module 118. Close inspection of the bottom chromatogram in FIG. 7B shows not only a retention time shift, but also a baseline offset. The chromatogram that failed the peak evaluation due to retention time shift also has a high baseline offset. The baseline offset was not chosen as a parameter to monitor, so the system did not alert the user of this phenomenon thus possibly requiring user interaction. The answer to the next question in the decision tree, “Is the column bleed high?” is yes. Thus, the likely cause of the chromatographic performance degradation is initially considered to be stationary phase degradation.

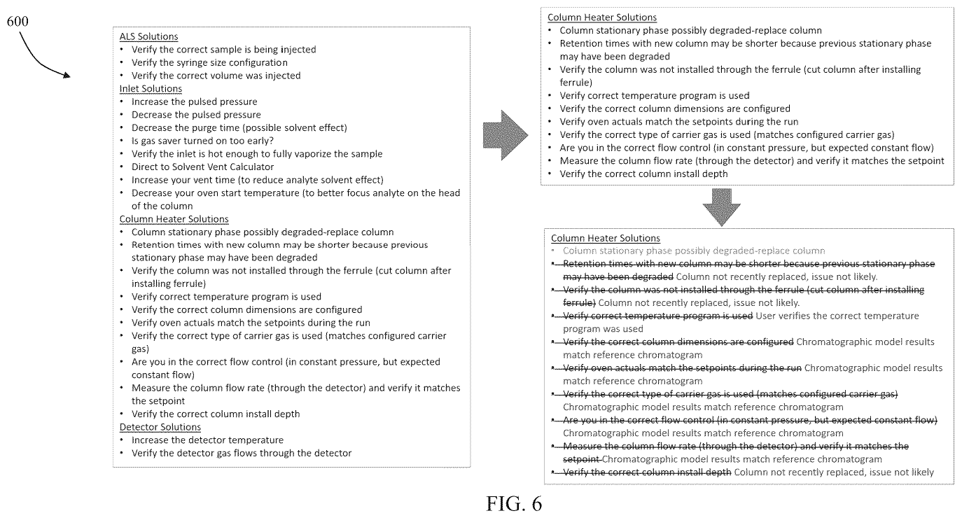

The list 600 in FIG. 6 shows the initial list of possible troubleshooting solutions. Based on the chromatographic symptoms, the issue was initially thought to be within the column or oven. The chromatographic modelling results can be very useful in pruning down the list and pinpointing the issue. In this example, the nominal chromatogram generated using the chromatographic model and the chromatographic setpoints and the real-time simulated chromatogram based on instrument data (i.e. measured thermal and pneumatic values) from the chromatographic run agree with each other. Additionally, both simulated chromatograms also agree with the original reference chromatogram. Because the nominal and real-time simulated chromatograms match each other, it means the measured thermal and pneumatic values were at the expected setpoints during the run, therefore were in control and the GC hardware can be considered functioning properly. This can also be verified by analyzing the instrument data for the oven temperature and comparing it to the expected oven temperature setpoint. These were determined to be matching. The same process can be done for the pneumatic values as well. Visual inspection of the chromatogram in FIG. 7B shows a similar looking chromatogram just shifted left, indicating the same sample was injected, thus ruling out some sample introduction system related issues (e.g., ALS issues). Additionally, since both models matched the reference chromatogram, it can be deduced that something outside of the GC system control or knowledge has changed the chromatographic performance. Additionally, the GC has maintained the same configuration through the entire sample analysis so the chromatographic degradation could not be due to a configuration change or maintenance issue (e.g. the column was changed). The only remaining solution in FIG. 6 that meets all of the criteria that matches the chromatographic behavior is that the column stationary phase has possibly aged or degraded.

Different analyses will affect the GC system in different ways, allowing a wide range of duration before performance degradation. Many samples are ‘clean’ in that they have few contaminants which could damage the system. This may lead to a relatively long time before chromatographic degradation is observed. Other samples may be dirty and leave behind unwanted residue which may damage parts of the system and cause performance degradation relatively quickly. Some methods require very high temperature programs which can damage column stationary phases. Additionally, contaminated carrier gas or a leaky fitting can allow oxygen ingress into the system which can rapidly cause column stationary phase damage. The control charting is very useful because of the variability in duration before a system may exhibit performance degradation. In this example, the failure occurred quickly (as noted in the control chart in FIG. 7C), but in some instances the system may last many hundreds of injections before chromatographic performance degradation becomes noticeable.

After the user performs the suggested procedures and/or maintenance tasks, the GC system 100 automatically performs (or instructs the user to perform) a verification run. If the retention times return to normal as determined by comparing the sample chromatogram from the verification run to the reference chromatogram and/or simulated chromatogram (and the user agrees with the results), the reference chromatogram can be updated by replacing the reference chromatogram with the verification sample chromatogram. As such, the GC system 100 resumes normal instrument operation and the diagnostic and predictive module 118 updates the maintenance indication line 350 of the control chart 300 to show the change in instrument performance based on the performed adjustments and/or maintenance tasks. On the other hand, if the retention times do not return to normal, the diagnostic and predictive module 118 continues to investigate other components of the GC system (e.g., inlet, sample introduction system, and/or detector). In certain embodiments, the diagnostic and predictive module 118 automatically (or by user instruction) generates a maintenance report including the user and/or GC system 100 provided input during the automated troubleshooting procedure. The maintenance report further includes the tasks and/or maintenance tasks performed during the automated troubleshooting procedure and the results. The diagnostic and predictive module then saves the maintenance report for future reference.

The disclosures of all patents, publications and literature identified herein are specifically incorporated herein by reference.

It is to be understood that the terminology used herein is for purposes of describing particular embodiments only and is not intended to be limiting. The defined terms are in addition to the technical and scientific meanings of the defined terms as commonly understood and accepted in the technical field of the present teachings.

The terms “a”, “an” and “the” include both singular and plural referents, unless the context clearly dictates otherwise. Thus, for example, “a device” includes one device and plural devices. Unless otherwise indicated, the terms “first”, “second”, “third”, and other ordinal numbers are used herein to distinguish different elements of the present devices and methods, and are not intended to supply a numerical limit. Reference to first and second elements should not be interpreted to mean that the device only has two elements. A device having first and second elements can also include a third, a fourth, a fifth, and so on, unless otherwise indicated.

As used herein, the terms “nominal values” or “ideal values” or “setpoints” mean values determined abstractly, theoretically, or from a reference, and not from actual measurement during operation. For example, if a GC method specifies the column heater holds the temperature at 40° C. for 1 minute, then increase the temperature from 40° C. to 60° C. in 20 seconds, the nominal value (at a specific time point) would be the temperature based on the defined program and not the exact column heater temperature at that specific time point as measured by a sensor. However, the GC system has a temperature sensor that measures and records the actual temperature of the column heater which may be slightly different than the pre-determined nominal value.

As used in the specification and the appended claims and in addition to its ordinary meaning, the term “chromatographic model” refers to a program, software, or algorithm that uses data regarding chemical properties about a sample or one or more analytes in a sample, in combination with data regarding a GC method and/or configuration to predict one or more chromatographic parameters for one or more analytes in the sample if subjected to a chromatographic separation by the GC method and/or configuration.

As used in the specification and the appended claims and in addition to its ordinary meaning, the term “chromatographic parameter” refers to any parameter that can be measured by a GC system, including but not limited to a retention time, a peak height, a peak area, a peak width, a peak symmetry, and a peak resolution of an analyte pair.

As used in the specification and the appended claims and in addition to its ordinary meaning, the term “performance data” refers to data obtained, derived from, or otherwise related to performing a chromatographic separation, including but not limited to sample data and instrument data. Sample data refers to data about a sample subjected to the separation (such as retention time and other chromatographic parameters), and instrument data refers to data about the instrument (such as temperature, pressure, power demand, or others).

As used in the specification and the appended claims and in addition to its ordinary meaning, the term “connected” means that two components are fluidically connected, or physically connected, or both. The term “fluidically connected” means that two components are in fluid communication and includes direct connections between the two components as well as indirect connections where one or more other components are in the flow path between the two components. For example, a first component and a second component are fluidically connected if an outlet from the first component is physically connected to an inlet of the second component, or if a conduit connects the first and second components, or if one or more intervening components, such as a valve, a pump, or other structure, is between the two components as fluid flows from the first component to the second component, or vice versa. Components can be physically connected in any suitable way, such as by using ferrules, brazing, and other approaches. In general, physical connections that are fluid-tight and/or that minimize dead-volume are desired for the present apparatus.

In the detailed description herein, for purposes of explanation and not limitation, representative embodiments disclosing specific details are set forth in order to provide a thorough understanding of the present teachings. Descriptions of known systems, devices, materials, methods of operation and methods of manufacture may be omitted so as to avoid obscuring the description of the example embodiments. Nonetheless, systems, devices, materials, and methods that are within the purview of one of ordinary skill in the art may be used in accordance with the representative embodiments.

Generally, it is understood that the drawings and the various elements depicted therein are not drawn to scale. Further, relative terms, such as “above,” “below,” “top,” “bottom,” “upper,” “lower,” “left,” “right,” “vertical” and “horizontal,” are used to describe the various elements' relationships to one another, as illustrated in the accompanying drawings. It is understood that these relative terms are intended to encompass different orientations of the microfluidic contaminant devices and/or elements in addition to the orientation depicted in the drawings.

### EXEMPLARY EMBODIMENTS

Exemplary embodiments provided in accordance with the presently disclosed subject matter include, but are not limited to, the following:

Embodiment 1. A method for operating a gas chromatography (GC) system, the method comprising:
generating a simulated chromatographic separation using a chromatographic model based on a configuration of the GC system, wherein the chromatographic model calculates at least one chromatographic parameter of a sample analyzed by the GC system;
performing a sample chromatographic separation using the GC system, thereby generating a sample chromatogram of the sample analyzed by the GC system;
collecting performance data associated with the sample chromatographic separation, wherein the performance data comprises the at least one chromatographic parameter of the sample;
performing a chromatographic performance monitoring configured to analyze the sample chromatographic separation, wherein the chromatographic performance monitoring comprises a comparison of the at least one chromatographic parameter of the sample chromatographic separation to the simulated chromatographic separation and/or a reference chromatographic separation and determines if the at least one chromatographic parameter of the sample chromatographic separation has fallen outside a performance control limit and/or predicts if and/or when the at least one chromatographic parameter of the sample chromatographic separation may fall outside the performance control limit;
performing an automated GC troubleshooting procedure that uses results of the chromatographic performance monitoring and the chromatographic model to predict an expected maintenance task of the GC system; and
transmitting a maintenance notification of the GC system including the expected maintenance task.

Embodiment 2. The method of embodiment 1, wherein the at least one chromatographic parameter comprises one or more of a retention time, a relative retention time, a retention index, an adjusted retention time, a peak height, a peak area, a peak width, a peak symmetry, a peak resolution, a peak capacity, a skew, a kurtosis, a Trennzahl, a capacity factor, a selectivity, an efficiency, an apparent efficiency, a tailing factor, a concentration, and a mole quantity of an analyte analyzed by the GC system.

Embodiment 3. The method of embodiment 1, wherein the automated troubleshooting procedure also uses instrument data from the sample chromatographic separation to determine the expected maintenance task, and wherein transmitting the maintenance notification comprises determining the expected maintenance task from a plurality of different maintenance tasks and alerting a user of the GC system to the expected maintenance task.

Embodiment 4. The method of embodiment 3, wherein the instrument data comprises one or more of a temperature value, a pressure sensor value, a valve state, a motor step, a sample injection count, a motor duty cycle, a heater current value, a heater duty cycle, a motor current value, a flow sensor value, a detector signal value, a detector current value, a detector frequency value, a calibration table, an auto-zero value, a sensor zero value, a time on value, and a valve duty cycle value of the GC system.

Embodiment 5. The method of embodiment 1, wherein the automated troubleshooting procedure performs one or more diagnostic tests to determine the expected maintenance task.

Embodiment 6. The method of embodiment 1, wherein the chromatographic model utilizes actual instrument values of the GC system collected in real-time during the sample chromatographic separation performed by the GC system.

Embodiment 7. The method of embodiment 1, wherein the automated troubleshooting procedure utilizes a decision tree to determine the expected maintenance task.

Embodiment 8. The method of embodiment 7, wherein a user inputs information into the decision tree.

Embodiment 9. The method of embodiment 7, wherein the decision tree further determines performance of the expected maintenance task on one or more of a sample introduction system, a sample inlet, a column, a column heater, and a detector of the GC system to correct the at least one chromatographic parameter being outside of the performance control limit and/or expected to be outside of the performance control limit.

Embodiment 10. The method of embodiment 1, wherein the automated troubleshooting procedure further utilizes a neural network to determine a correlation between the expected maintenance task and the chromatographic parameter being outside of the performance control limit and/or expected to be outside of the performance control limit.

Embodiment 11. The method of embodiment 1, wherein the automated troubleshooting procedure further utilizes a machine learning process to teach the GC system that the expected maintenance task is associated with the chromatographic parameter being outside of the performance control limit and/or expected to be outside of the performance control limit.

Embodiment 12. The method of embodiment 1, wherein the automated troubleshooting procedure utilizes a neural network to associate one or more expected maintenance tasks with correction of the chromatographic parameter being outside of the performance control limit and/or expected to be outside of the performance control limit, and wherein if the chromatographic parameter being outside of the performance control limit and/or expected to be outside of the performance control limit is a recurring GC system issue the neural network determines an alternative maintenance task to correct the recurring GC system issue.

Embodiment 13. The method of embodiment 1, wherein the automated troubleshooting procedure further comprises performing the expected maintenance task on one or more of a sample introduction system, a sample inlet, a column, a column heater, and a detector of the GC system to correct the chromatographic parameter being outside of the performance control limit and/or expected to be outside of the performance control limit.

Embodiment 14. The method of embodiment 1, further comprising performing a verification chromatographic separation after performing the expected maintenance task, wherein the verification chromatographic separation is compared to the simulated chromatographic separation or a previous reference chromatogram to verify that the expected maintenance task corrects the at least one chromatographic parameter from being outside of the performance control limit and/or expected to be outside of the performance control limit.

Embodiment 15. The method of embodiment 14, wherein if the verification chromatographic separation verifies that the at least one chromatographic parameter is within the performance control limit, the verification chromatographic separation replaces the reference chromatographic separation.

Embodiment 16. The method of embodiment 1, wherein the chromatographic performance monitoring comprises plotting a control chart including the at least one chromatographic parameter of the sample and a sample injection count, wherein the control chart is utilized to extrapolate data of the at least one chromatographic parameter to predict if and/or when the at least one chromatographic parameter will be outside of the performance control limit, and wherein the control chart is utilized to generate the maintenance notification of an expected GC system failure prior to the at least one chromatographic parameter of the sample being outside of the performance control limit and/or expected to be outside of the performance control limit.

Embodiment 17. The method of embodiment 1, wherein generating the simulated chromatographic separation comprises generating a nominal simulated chromatogram and a real-time simulated chromatogram, and wherein utilizing the chromatographic model comprises comparing the real-time simulated chromatogram to the nominal simulated chromatogram.

Embodiment 18. The method of embodiment 1, wherein utilizing the chromatographic model during the troubleshooting procedure comprises a comparison between two or more of a nominal simulated chromatogram, a real-time simulated chromatogram, the reference chromatographic separation, and the sample chromatographic separation.

Embodiment 19. The method of embodiment 18, wherein if the real-time simulated chromatogram agrees with at least one of the nominal simulated chromatogram and the reference chromatographic separation but the real-time simulated chromatogram does not agree with the sample chromatographic separation, the automated troubleshooting procedure determines that the GC system is being controlled as expected and something outside control of the GC system is causing the at least one chromatographic parameter to fall outside the performance control limit.

Embodiment 20. The method of embodiment 18, wherein if the real-time simulated chromatogram agrees with the sample chromatographic separation but the real-time simulated chromatogram and the sample chromatographic separation does not agree with at least one of the nominal simulated chromatogram and the reference chromatographic separation, the automated troubleshooting procedure determines the GC system is not being controlled as expected and control of the GC system is causing the at least one chromatographic parameter to fall outside the performance control limit.

Embodiment 21. A gas chromatography (GC) system for analyzing a sample, the GC system comprising:
a GC column comprising an entrance and an exit, wherein the GC column is configured for chromatographic separation of a sample comprising one or more analytes;
a GC detector fluidically connected to the exit of the GC column; and
a controller communicably connected to at least the GC detector, the controller configured to:
   generate a simulated chromatographic separation using a chromatographic model based on a configuration of the GC system, wherein the chromatographic model calculates at least one chromatographic parameter of the sample analyzed by the GC system,
   execute a sample chromatographic separation of the sample loaded into the GC system,
   collect performance data associated with the sample chromatographic separation, wherein the performance data comprises the at least one chromatographic parameter of the sample chromatographic separation,
   execute a chromatographic performance monitoring configured to analyze the sample chromatographic separation, wherein the chromatographic performance monitoring comprises a comparison of the at least one chromatographic parameter of the sample chromatographic separation to the simulated chromatographic separation and/or a reference chromatographic separation to determine if the at least one chromatographic parameter of the sample chromatographic separation has fallen outside of a performance control limit and/or to predict if and/or when the at least one chromatographic parameter of the sample chromatographic separation will fall outside the performance control limit,
   execute an automated GC troubleshooting procedure that uses results of the chromatographic performance monitoring and the chromatographic model to predict an expected maintenance task of the GC system, and
   transmit a maintenance notification including the expected maintenance task to a user of the GC system.

Embodiment 22. The GC system of embodiment 21, wherein the at least one chromatographic parameter comprises one or more of a retention time, a relative retention time, a retention index, an adjusted retention time, a peak height, a peak area, a peak width, a peak symmetry, a peak resolution, a peak capacity, a skew, a kurtosis, a Trennzahl, a capacity factor, a selectivity, an efficiency, an apparent efficiency, a tailing factor, a concentration, and a mole quantity of an analyte analyzed by the GC system..

Embodiment 23. The GC system of embodiment 21, further comprising at least one instrument sensor communicably connected to the controller and configured to collect instrument data, wherein the instrument data comprises one or more of a temperature value, a pressure sensor value, a valve state, a motor step, a sample injection count, a motor duty cycle, a heater current value, a heater duty cycle, a motor current value, a flow sensor value, a detector signal value, a detector current value, a detector frequency value, a calibration table, an auto-zero value, a sensor zero value, a time on value, and a valve duty cycle value of the GC system.

Embodiment 24. The GC system of embodiment 23, wherein the controller provides the chromatographic model with actual instrument values of the GC system collected in real-time by the at least one instrument sensor.

Embodiment 25. The GC system of embodiment 23, wherein the controller performs one or more diagnostic tests to determine the expected maintenance task during the automated troubleshooting procedure.

Embodiment 26. The GC system of embodiment 21, wherein the controller generates a decision tree for the automated troubleshooting procedure.

Embodiment 27. The GC system of embodiment 26, wherein the user of the GC system inputs information into the decision tree.

Embodiment 28. The GC system of embodiment 26, wherein the controller utilizes the decision tree to determine the expected maintenance task to perform on one or more of a sample introduction system, a sample inlet, a column, a column heater, and a detector of the GC system to correct the chromatographic parameter being outside of the performance control limit and/or expected to be outside of the performance control limit.

Embodiment 29. The GC system of embodiment 21, wherein the controller utilizes a neural network during the automated troubleshooting procedure to determine a correlation between the expected maintenance task and the chromatographic parameter being outside of the performance control limit and/or expected to be outside of the performance control limit.

Embodiment 30. The GC system of embodiment 21, wherein the controller utilizes a machine learning process during the automated troubleshooting procedure to teach the GC system that the expected maintenance task is associated with the chromatographic parameter being outside of the performance control limit and/or expected to be outside of the performance control limit.

Embodiment 31. The GC system of embodiment 21, wherein the controller utilizes a neural network associated with one or more expected maintenance tasks with correction of the chromatographic parameter being outside of the performance control limit and/or expected to be outside of the performance control limit, and wherein if the chromatographic parameter being outside of the performance control limit and/or expected to be outside of the performance control limit is a recurring GC system issue the neural network determines an alternative maintenance task to correct the recurring GC system issue.

Embodiment 32. The GC system of embodiment 21, wherein the controller executes a verification chromatographic separation after performance of the expected maintenance task, wherein the verification chromatographic separation is compared to the simulated chromatographic separation and/or the reference chromatographic separation to verify that the expected maintenance task corrects the at least one chromatographic parameter from being outside of the performance control limit and/or expected to be outside of the performance control limit.

Embodiment 33. The GC system of embodiment 32, wherein if the verification chromatographic separation verifies that the at least one chromatographic parameter is within the performance control limit, the controller replaces the reference chromatographic separation with the verification chromatographic separation.

Embodiment 34. The GC system of embodiment 21, wherein during the chromatographic performance monitoring the controller generates a control chart including the at least one chromatographic parameter of the sample and a sample injection count, and wherein the controller extrapolates data of the at least one chromatographic parameter to predict if and/or when the at least one chromatographic parameter will be outside of the performance control limit.

Embodiment 35. The GC system of embodiment 21, wherein utilizing the chromatographic model during the troubleshooting procedure comprises the controller comparing two or more of a nominal simulated chromatogram, a real-time simulated chromatogram, the reference chromatographic separation, and the chromatographic separation of the sample.

Embodiment 36. The GC system of embodiment 35, wherein if the real-time simulated chromatogram agrees with at least one of the nominal simulated chromatogram and the reference chromatographic separation but the real-time simulated chromatogram does not agree with the chromatographic separation of the sample, the automated troubleshooting procedure determines that the GC system is being controlled as expected and something outside control of the GC system is causing the at least one chromatographic parameter to fall outside the performance control limit.

Embodiment 37. The GC system of embodiment 35, wherein if the real-time simulated chromatogram agrees with the chromatographic separation of the sample but the real-time simulated chromatogram and the chromatographic separation of the sample does not agree with at least one of the nominal simulated chromatogram and the reference chromatographic separation, the automated troubleshooting procedure determines the GC system is not being controlled as expected and control of the GC system is causing the at least one chromatographic parameter to fall outside the performance control limit.

Embodiment 38. A gas chromatography (GC) system for analyzing a sample, the GC system comprising:
a GC column comprising an entrance and an exit, wherein the GC column is configured for chromatographic separation of a sample comprising one or more analytes;
a GC detector fluidically connected to the exit of the GC column;
at least one sensor configured to collect instrument data of the GC system; and
a controller communicably connected to the GC detector, and the at least one sensor, the controller configured to:
   execute a chromatographic separation of the sample loaded into the GC system; and
   generate a simulated chromatographic separation of the sample utilizing the instrument data collected by the at least one sensor; wherein the controller is configured to generate the simulated chromatographic separation in real-time during the chromatographic separation of the sample.

Embodiment 39. The GC system of embodiment 38, wherein the instrument data collected by the at least one sensor comprises one or more of a temperature value, a pressure sensor value, a valve state, a motor step, a sample injection count, a motor duty cycle, a heater current value, a heater duty cycle, a motor current value, a flow sensor value, a detector signal value, a detector current value, a detector frequency value, a calibration table, an auto-zero value, a sensor zero value, a time on value, and a valve duty cycle value of the GC system.

Embodiment 40. The GC system of embodiment 38, wherein the simulated chromatographic separation is generated from a chromatographic model based on a configuration of the GC system.

Embodiment 41. The GC system of embodiment 40, wherein the chromatographic model calculates at least one chromatographic parameter comprising at least one of a retention time, a peak height, a peak area, a peak width, a peak symmetry, and a peak resolution of the sample analyzed by the GC system.

Embodiment 42. The GC system of embodiment 38, wherein the controller executes a chromatographic performance monitoring configured to analyze the chromatographic separation of the sample, and wherein the chromatographic performance monitoring comprises a comparison of at least one chromatographic parameter to the simulated chromatographic separation and/or a reference chromatographic separation and determines if the at least one chromatographic parameter has fallen outside of a performance control limit and/or predicts if and/or when the at least one chromatographic parameter will fall outside of the performance control limit.

Embodiment 43. The GC system of embodiment 42, wherein the controller executes an automated troubleshooting procedure that utilizes the chromatographic performance monitoring and the simulated chromatographic separation to predict an expected maintenance task of the GC system, and wherein the automated troubleshooting procedure determines the expected maintenance task from a plurality of different maintenance tasks to correct the at least one chromatographic parameter being outside of the performance control limit and/or expected to be outside of the performance control limit.

Embodiment 44. The GC system of embodiment 43, wherein the controller executes a verification chromatographic separation after a user of the GC system performs the expected maintenance task selected from the plurality of different maintenance tasks, and wherein the verification chromatographic separation is compared to the simulated chromatographic separation and/or the reference chromatographic separation to verify that the expected maintenance task corrects the at least one chromatographic parameter from being outside of the performance control limit and/or expected to be outside of the performance control limit.

Embodiment 45. The GC system of embodiment 44, wherein if the verification chromatographic separation verifies that the at least one chromatographic parameter is within the performance control limit, the controller replaces the reference chromatographic separation with the verification chromatographic separation.

Embodiment 46. A method for operating a gas chromatography (GC) system, the method comprising:
generating a simulated chromatographic separation using a chromatographic model based on a configuration of the GC system, wherein the chromatographic model calculates at least one chromatographic parameter of a sample analyzed by the GC system;
performing a sample chromatographic separation using the GC system, thereby generating a sample chromatogram of the sample analyzed by the GC system;
collecting performance data associated with the sample chromatographic separation, wherein the performance data comprises the at least one chromatographic parameter of the sample;
performing an automated GC troubleshooting procedure that uses results of the chromatographic model and the sample chromatographic separation to predict an expected maintenance task of the GC system; and
transmitting a maintenance notification of the GC system including the expected maintenance task.

Embodiment 47. A method for operating a gas chromatography (GC) system, the method comprising:
performing a sample chromatographic separation using the GC system, thereby generating a sample chromatogram of a sample analyzed by the GC system;
collecting instrument data associated with the sample chromatographic separation, the instrument data comprising at least one sensor value;
performing a chromatographic performance monitoring configured to analyze the sample chromatographic separation, wherein the chromatographic performance monitoring comprises determining if the at least one sensor value has fallen outside a performance control limit and/or predicts if and/or when the at least one sensor value may fall outside the performance control limit;
performing an automated GC troubleshooting procedure that uses the chromatographic performance monitoring and a chromatographic model of the GC system to predict an expected maintenance task of the GC system; and
transmitting a maintenance notification of the GC system including the expected maintenance task.

In view of this disclosure it is noted that the methods and devices can be implemented in keeping with the present teachings. Further, the various components, materials, structures and parameters are included by way of illustration and example only and not in any limiting sense. In view of this disclosure, the present teachings can be implemented in other applications and components, materials, structures and equipment needed to implement these applications can be determined, while remaining within the scope of the appended claims.

1. A method for operating a gas chromatography (GC) system, the method comprising:
generating a simulated chromatographic separation using a chromatographic model based on a configuration of the GC system, wherein the chromatographic model calculates at least one chromatographic parameter of a sample analyzed by the GC system;
performing a sample chromatographic separation using the GC system, thereby generating a sample chromatogram of the sample analyzed by the GC system;
collecting performance data associated with the sample chromatographic separation, wherein the performance data comprises the at least one chromatographic parameter of the sample;
performing a chromatographic performance monitoring configured to analyze the sample chromatographic separation, wherein the chromatographic performance monitoring comprises a comparison of the at least one chromatographic parameter of the sample chromatographic separation to the simulated chromatographic separation and/or a reference chromatographic separation and determines if the at least one chromatographic parameter of the sample chromatographic separation has fallen outside a performance control limit and/or predicts if and/or when the at least one chromatographic parameter of the sample chromatographic separation may fall outside the performance control limit;
performing an automated GC troubleshooting procedure that uses results of the chromatographic performance monitoring and the chromatographic model to predict an expected maintenance task of the GC system; and
transmitting a maintenance notification of the GC system including the expected maintenance task.

2. The method of claim 1, wherein the at least one chromatographic parameter comprises one or more of a retention time, a relative retention time, a retention index, an adjusted retention time, a peak height, a peak area, a peak width, a peak symmetry, a peak resolution, a peak capacity, a skew, a kurtosis, a Trennzahl, a capacity factor, a selectivity, an efficiency, an apparent efficiency, a tailing factor, a concentration, and a mole quantity of an analyte analyzed by the GC system.

3. The method of claim 1, wherein the automated troubleshooting procedure also uses instrument data from the sample chromatographic separation to determine the expected maintenance task, and wherein transmitting the maintenance notification comprises determining the expected maintenance task from a plurality of different maintenance tasks and alerting a user of the GC system to the expected maintenance task.

4. The method of claim 3, wherein the instrument data comprises one or more of a temperature value, a pressure sensor value, a valve state, a motor step, a sample injection count, a motor duty cycle, a heater current value, a heater duty cycle, a motor current value, a flow sensor value, a detector signal value, a detector current value, a detector frequency value, a calibration table, an auto-zero value, a sensor zero value, a time on value, and a valve duty cycle value of the GC system.

5. The method of claim 1, wherein the automated troubleshooting procedure performs one or more diagnostic tests to determine the expected maintenance task.

6. The method of claim 1, wherein the chromatographic model utilizes actual instrument values of the GC system collected in real-time during the sample chromatographic separation performed by the GC system.

7. The method of claim 1, wherein the automated troubleshooting procedure utilizes a decision tree to determine the expected maintenance task.

8. The method of claim 7, wherein a user inputs information into the decision tree.

9. The method of claim 7, wherein the decision tree further determines performance of the expected maintenance task on one or more of a sample introduction system, a sample inlet, a column, a column heater, and a detector of the GC system to correct the at least one chromatographic parameter being outside of the performance control limit and/or expected to be outside of the performance control limit.

10. The method of claim 1, wherein the automated troubleshooting procedure further utilizes a neural network to determine a correlation between the expected maintenance task and the chromatographic parameter being outside of the performance control limit and/or expected to be outside of the performance control limit.

11. The method of claim 1, wherein the automated troubleshooting procedure further utilizes a machine learning process to teach the GC system that the expected maintenance task is associated with the chromatographic parameter being outside of the performance control limit and/or expected to be outside of the performance control limit.

12. The method of claim 1, wherein the automated troubleshooting procedure utilizes a neural network to associate one or more expected maintenance tasks with correction of the chromatographic parameter being outside of the performance control limit and/or expected to be outside of the performance control limit, and wherein if the chromatographic parameter being outside of the performance control limit and/or expected to be outside of the performance control limit is a recurring GC system issue the neural network determines an alternative maintenance task to correct the recurring GC system issue.

13. The method of claim 1, wherein the automated troubleshooting procedure further comprises performing the expected maintenance task on one or more of a sample introduction system, a sample inlet, a column, a column heater, and a detector of the GC system to correct the chromatographic parameter being outside of the performance control limit and/or expected to be outside of the performance control limit.

14. The method of claim 1, further comprising performing a verification chromatographic separation after performing the expected maintenance task, wherein the verification chromatographic separation is compared to the simulated chromatographic separation or a previous reference chromatogram to verify that the expected maintenance task corrects the at least one chromatographic parameter from being outside of the performance control limit and/or expected to be outside of the performance control limit.

15. The method of claim 14, wherein if the verification chromatographic separation verifies that the at least one chromatographic parameter is within the performance control limit, the verification chromatographic separation replaces the reference chromatographic separation.

16. The method of claim 1, wherein the chromatographic performance monitoring comprises plotting a control chart including the at least one chromatographic parameter of the sample and a sample injection count, wherein the control chart is utilized to extrapolate data of the at least one chromatographic parameter to predict if and/or when the at least one chromatographic parameter will be outside of the performance control limit, and wherein the control chart is utilized to generate the maintenance notification of an expected GC system failure prior to the at least one chromatographic parameter of the sample being outside of the performance control limit and/or expected to be outside of the performance control limit.

17. The method of claim 1, wherein generating the simulated chromatographic separation comprises generating a nominal simulated chromatogram and a real-time simulated chromatogram, and wherein utilizing the chromatographic model comprises comparing the real-time simulated chromatogram to the nominal simulated chromatogram.

18. The method of claim 1, wherein utilizing the chromatographic model during the troubleshooting procedure comprises a comparison between two or more of a nominal simulated chromatogram, a real-time simulated chromatogram, the reference chromatographic separation, and the sample chromatographic separation.

19-20. (canceled)

21. A gas chromatography (GC) system for analyzing a sample, the GC system comprising:
a GC column comprising an entrance and an exit, wherein the GC column is configured for chromatographic separation of a sample comprising one or more analytes;
a GC detector fluidically connected to the exit of the GC column; and
a controller communicably connected to at least the GC detector, the controller configured to:
generate a simulated chromatographic separation using a chromatographic model based on a configuration of the GC system, wherein the chromatographic model calculates at least one chromatographic parameter of the sample analyzed by the GC system,
execute a sample chromatographic separation of the sample loaded into the GC system,
collect performance data associated with the sample chromatographic separation, wherein the performance data comprises the at least one chromatographic parameter of the sample chromatographic separation,
execute a chromatographic performance monitoring configured to analyze the sample chromatographic separation, wherein the chromatographic performance monitoring comprises a comparison of the at least one chromatographic parameter of the sample chromatographic separation to the simulated chromatographic separation and/or a reference chromatographic separation to determine if the at least one chromatographic parameter of the sample chromatographic separation has fallen outside of a performance control limit and/or to predict if and/or when the at least one chromatographic parameter of the sample chromatographic separation will fall outside the performance control limit,
execute an automated GC troubleshooting procedure that uses results of the chromatographic performance monitoring and the chromatographic model to predict an expected maintenance task of the GC system, and
transmit a maintenance notification including the expected maintenance task to a user of the GC system.

22-37. (canceled)

38. A gas chromatography (GC) system for analyzing a sample, the GC system comprising:
a GC column comprising an entrance and an exit, wherein the GC column is configured for chromatographic separation of a sample comprising one or more analytes;
a GC detector fluidically connected to the exit of the GC column;
at least one sensor configured to collect instrument data of the GC system; and
a controller communicably connected to the GC detector, and the at least one sensor, the controller configured to:
execute a chromatographic separation of the sample loaded into the GC system; and
generate a simulated chromatographic separation of the sample utilizing the instrument data collected by the at least one sensor; wherein the controller is configured to generate the simulated chromatographic separation in real-time during the chromatographic separation of the sample.

39-47. (canceled)
